(19) United States
(12) Patent Application Publication
(10) Pub. No.: US 2014/0160085 A1
(43) Pub. Date: Jun. 12, 2014

(54) ADAPTIVE ANALOG-FRONT-END TO OPTIMIZE TOUCH PROCESSING

(71) Applicant: QUALCOMM INCORPORATED, San Diego, CA (US)

(72) Inventors: Khosro M. Rabii, San Diego, CA (US); Lalan Mishra, San Diego, CA (US)

(73) Assignee: QUALCOMM Incorporated, San Diego, CA (US)

(21) Appl. No.: 13/707,932

(22) Filed: Dec. 7, 2012

(51) Int. Cl. G06F 3/041

(52) U.S. Cl. CPC G06F 3/0416
USPC 345/178

(57) ABSTRACT

In various aspects a host processor and a touchscreen controller may concurrently process a signal sent by a touch transducer when a touch is detected. A touch signal sent directly from a touch transducer may be formatted into a calibrated touch signal that the host processor can process. The calibrated touch signal may allow the host processor to receive and process touch signals from transducers and touchscreens from various manufacturers. The touchscreen controller and the host processor may each independently assess the touch-processing state. The touch-processing state may be set to one of a plurality of “states,” and the plurality of states may have rules for transitioning between the states. In various aspects, a host processor and a touchscreen controller may dynamically set, among other things, the scanning rate and resolution of a touchscreen panel based on the touch-processing state.

### BACKGROUND

Modern computing devices, such as mobile smartphones and tablets, may utilize touchscreen capabilities to gather and process user touch signal data. These touch-sensitive devices may contain hundreds of touch nodes managed by a touchscreen controller which processes detected touch input, executing related commands based on the input. The power required to process touch signal data may be proportional to the size of the touchscreen (i.e., screen size), as larger touchscreens may have larger touch node capacities. As the size and fidelity of touchscreens on computing devices rapidly increases and the corresponding user input applied to these devices becomes more complex, the touchscreen controller may become inadequate (e.g., in terms of memory, MIPS, and real-time operating systems) to satisfactorily process such data. In fact, touchscreen controllers in touchscreen computing devices with large displays are known to regularly operate under-resourced, often sacrificing scan-rate, which lowers response-time. For example, the touchscreen controller may not be able to keep up with many and rapid user touches on the screen, such as dual hand multi-touch on a soft-QWERTY keyboard, leading to missed user inputs and degraded performance, both of which will impact the user experience.

Because there is an increasing demand for touchscreen devices that are larger and can facilitate an increasing variety of multi-touching gestures, and because the current touchscreen controllers are increasingly becoming incapable of maintaining an adequate quality of service for larger devices with more touches, there is a need for a more efficient method of accomplishing touch processing (i.e., translating detected touches into processor inputs) in touchscreen devices. Also, because larger touchscreen computing devices may expend more battery power to scan and process touch signal data, there is also a need for a more efficient method of receiving touch signal data to conserve battery power.

### SUMMARY

The various aspects promote reliable and efficient touch processing by enabling a host processor and a touchscreen controller to process touch signal data jointly or concurrently, thereby contributing to the speed and accuracy of touch processing. The various aspects may also promote efficient touch processing by decreasing the amount of overall touch processing conducted on the touchscreen computing device while the touchscreen panel is not being used. The various aspects may promote touch processing efficiency, prolonged battery life, and improved overall user experience.

In some aspects, the touchscreen controller may function together with a host processor to determine the touch-processing state, a measure of the current touch activity detected on the touchscreen panel (e.g., “active,” “standby,” or “sleep”). Traditionally this is accomplished by the touchscreen controller without input from the host processor. In various aspects, the host processor has access to application states and processes and information from numerous sensors (e.g., an accelerometer), and thus has information that may enable it to anticipate likely locations of user touch inputs.

In an aspect, the touchscreen controller and the host processor may independently assess whether touch processing is needed by determining the touch-processing state. For example, the touchscreen controller may process a touch signal from a transducer and determine that a user has touched the touchscreen screen, but the host processor may determine that no touch occurred because the location of the suspected touch did not correspond to an element with which a user may interact (e.g., no button is rendered at that location). In this example, the host processor's determination may be used because of the host processor's access to information unavailable to the touchscreen controller, including details of what is rendered on the display at the location of the purported touch. Based on whether a touch has been received, the touch-processing state may be set to, for example, one of “active,” “standby,” and “sleep,” which all may trigger different scanning and resolution rates in the touchscreen sensor to save power as discussed below.

In various aspects, the host processor and the touchscreen controller may concurrently process a signal sent by a touch transducer when a touch is detected. In an aspect, the host processor may perform signal processing traditionally only conducted in the touchscreen controller. For example, the host processor may correct and calibrate touch signals and may perform detection and segmentation. The host processor may also perform its traditional signal processing activities, including touch primitive detection, touch-primitive tracking, and symbol identification and gesture recognition.

In an aspect, the touchscreen controller may not perform signal processing and may be primarily responsible for instructing the touchscreen sensor to react to the current touch-processing state. For example, if the current touch-processing state is “standby,” the touchscreen controller may instruct the touchscreen sensor to minimize its touch resolution, thereby making detection of a touch location less precise while saving battery power. In a further aspect, a hosting processor may determine the touch-processing state and may direct the touchscreen controller to implement the corresponding resolution and scanning rate on the touchscreen.

In various aspects, a touch signal sent directly from a touch transducer may be calibrated for use by the host processor. The calibrated touch signal may allow the host processor to receive/process touch signals from transducers that have been adaptively amplified, over-sampled, correlating, and skewed.

In various aspects, a host processor and a touchscreen controller may dynamically set, among other things, the scanning rate and resolution of a touchscreen panel based on the touch-processing state. The touch-processing state may be set to one of a plurality of “states,” and the plurality of states may have rules for transitioning between the states.

In various aspects, the touchscreen controller and the host processor may each independently assess the touch-processing state. In an aspect, the touch-processing states may be: (1) an “active” state when touches are presently being received (e.g., actively typing on a soft QWERTY keyboard), (2) a “standby” state when the touchscreen panel is waiting for a touch (e.g., while the user watches a movie on the touchscreen computing device), and (3) a “sleep” state when no touch is anticipated in the near future (e.g., no activity has occurred on the touchscreen computing device for an hour).

In an aspect, the host processor and/or the touchscreen controller may change the resolution and/or scan rate of the touchscreen to conserve battery power and minimize response time for detecting a user's touch depending on the current touch-processing state. The scan rate may be the rate at which the touchscreen is scanned for touches, and the resolution may be the granularity of touch detection. For example, if the touchscreen computing device is in the “standby” state, the touchscreen may only scan for one touch anywhere on the screen, and when a touch to the touchscreen is received, the processor may set the touch-processing state to “active,” thereby causing the touchscreen panel to scan for the specific location of future touches. In this example, the resolution of the touchscreen panel may be lowered by aggregating the conductive rows and columns and adjusting the drive strength of an electric signal sent through the rows and columns to keep signal levels consistent (i.e., to avoid a drop or spike in voltage/current that may be interpreted as a touch event). In a further example, a touchscreen may only scan for a touch anywhere on the touchscreen while a user is watching a movie to save battery power and may begin scanning for a specific touch location when the user begins to use the touchscreen computing device again.

The various aspects include a method of processing a touch signal from a transducer front end of a computing device that may include a touchscreen panel by processing the touch signal jointly by a touchscreen controller and a host processor. In an aspect, processing the touch signal jointly by the touchscreen controller and the host processor may include receiving the touch signal on the host processor and determining whether a valid touch input occurred with the host processor. In another aspect, the method may include processing the touch signal by the host processor without contribution from the touchscreen controller. In a further aspect, the method may include using information from an application executing on the host processor to determine whether the touch signal is a valid touch input. In another aspect, the method may include using information from a sensor communicating data to the host processor to determine whether the touch signal is a valid touch input.

In another aspect, the method may include receiving the touch signal in the touchscreen controller, determining in the touchscreen controller whether a valid touch input occurred, comparing the valid touch input determinations made by the host processor and the touchscreen controller, and finding a valid touch input occurred based on the compared valid touch input determinations. In another aspect, the method may include using information from an application executing on the host processor to determine whether the touch signal is a valid touch input. In yet another aspect, the method may include using information from a sensor communicating data to the host processor to determine whether the touch signal is a valid touch input.

In another aspect, the method may include updating a touch-processing state based on an outcome of determining whether a valid touch input occurred. In a further aspect, the method may include updating a touchscreen-scanning setting. In an aspect, updating the touchscreen-scanning setting may include adaptively changing a touch resolution on a touchscreen area based on the touch-processing state by retrieving the touch-processing state and defining the touchscreen-scanning setting based on the touch-processing state. In a further aspect, the touchscreen-scanning setting may be one of an “active” setting, a “standby” setting, a “semi-active” setting, and a “sleep” setting. In another aspect, the touchscreen area may be at least a portion of a touchscreen panel.

In another aspect, the method may include maximizing the touch resolution in response to an “active” setting, minimizing the touch resolution in response to a “standby” setting, setting a mid-range touch resolution in response to a “semi-active” setting, and disabling the touchscreen panel in response to a “sleep” setting. In another aspect, minimizing the touch resolution in response to a “standby” setting may include aggregating all rows in the touchscreen area, aggregating all columns in the touchscreen area, adjusting a drive strength of a electronic signal sent through the touchscreen area to allow for scanning the aggregated rows and aggregated columns, and performing future scans of the touchscreen area for touches on the aggregated rows and the aggregated columns. In another aspect, maximizing the touch resolution in response to an “active” setting may include separating rows in the touchscreen area, separating columns in the touchscreen area, adjusting a drive strength of an electronic signal sent through the touchscreen area to allow for scanning individual rows and columns, and performing future scans of the touchscreen area for touches on individual rows and individual columns.

In another aspect, setting the mid-range touch resolution in response to a “semi-active” setting may include aggregating a plurality of rows in the touchscreen area, aggregating a plurality of columns in the touchscreen area, adjusting a drive strength of a electronic signal sent through the touchscreen area to allow for scanning the aggregated rows and aggregated columns, and performing future scans of the touchscreen area for touches on the aggregated rows and the aggregated columns. In another aspect, the plurality of rows may be less than a total number of rows of the touchscreen panel, and the plurality of columns may be less than a total number of columns of the touchscreen panel. In another aspect, disabling the touchscreen panel in response to a “sleep” setting may include disabling the touchscreen area, reducing a drive strength of a electronic signal sent through the touchscreen area to allow for no scanning, and not performing scans of the touchscreen area.

In another aspect, the method may include sending calibration parameters to the transducer front end in response to an invalid touch input. In another aspect, the method may include storing calibration parameters for use in calibrating a future touch signal. In another aspect, calibration parameters may be used to configure the transducer front end to calibrate a future touch signal sent from a touchscreen panel for use by the host processor. In another aspect, calibration parameters may be used to configure the transducer front end of the touchscreen panel to perform operations selected from a group that includes adaptively amplifying the future touch signal to normalize a signal-to-noise ratio caused by the transducer's location relative to the touchscreen panel, over-sampling the future touch signal to enhance the signal-to-noise ratio, correlating the future touch signal to enhance the signal-to-noise ratio, and skewing a digital approximation of the future touch signal from an analog-to-digital converter to mitigate noise.

Further aspects include a touchscreen computing device including various means for performing functions of the aspect methods described above. Further aspects include a touchscreen computing device including a touch screen display, a touchscreen controller coupled to the touchscreen panel, and a host processor coupled to the touchscreen controller and the touchscreen panel, in which the touchscreen controller and the host processor are each configured with processor-executable instructions to perform operations of the aspect methods described above. Further aspects include a processor suitable for use in a touchscreen computing device in which the processor is configured with processor executable instructions to perform operations of the aspect methods described above. Further aspects include a non-transitory processor-readable storage medium on which are stored processor executable instructions configured to cause a host processor of a touchscreen computing device to perform operations of the aspect methods described above.

A further aspect includes a host processor configured for use with a touchscreen computing device in which the host processor may be configured with processor-executable instructions to perform operations including receiving a touch signal, determining whether a valid touch input occurred, and sending calibration parameters directly to a transducer front end of the touchscreen panel in response to an invalid touch input. In a further aspect, the host processor may be configured with processor-executable instructions to perform operations such that calibration parameters configure the transducer front end to calibrate future touch signals sent from a touchscreen panel for use by the host processor. In a further aspect, the host processor may be configured with processor-executable instructions to perform operations such that calibration parameters configure the transducer front end of the touchscreen panel to perform operations selected from a group that includes adaptively amplifying the future touch signal to normalize a signal-to-noise ratio caused by the transducer's location relative to the touchscreen panel, over-sampling the future touch signal to enhance the signal-to-noise ratio, correlating the future touch signal to enhance the signal-to-noise ratio, and skewing a digital approximation of the future touch signal from an analog-to-digital converter to mitigate noise.

A further aspect includes a host processor configured for use with a touchscreen computing device in which the host processor may be configured with processor-executable instructions to perform operations including receiving a touch signal, determining whether a valid touch input occurred, and updating a touch-processing state based on a determination of whether a valid touch input occurred. In a further aspect, the host processor may be configured with processor-executable instructions to perform operations further comprising updating a touchscreen-scanning setting. In a further aspect, the host processor may be configured with processor-executable instructions to perform operations such that updating the touchscreen-scanning setting includes adaptively changing a touch resolution on a touchscreen area based on the touch-processing state by retrieving the touch-processing state, and defining the touchscreen-scanning setting based on the touch-processing state, in which the touchscreen-scanning setting may be one of an “active” setting, a “standby” setting, a “semi-active” setting, and a “sleep” setting, and in which the touchscreen area may be at least a portion of a touchscreen panel. In a further aspect, the host processor may be configured with processor-executable instructions to perform operations further including maximizing the touch resolution in response to an “active” setting, minimizing the touch resolution in response to a “standby” setting, setting a mid-range touch resolution in response to a “semi-active” setting, and disabling the touchscreen panel in response to a “sleep” setting. In a further aspect, the host processor may be configured with processor-executable instructions to perform operations such that minimizing the touch resolution in response to a “standby” setting may include aggregating all rows in the touchscreen area, aggregating all columns in the touchscreen area, adjusting a drive strength of a electronic signal sent through the touchscreen area to allow for scanning the aggregated rows and aggregated columns, and performing future scans of the touchscreen area for touches on the aggregated rows and the aggregated columns. In a further aspect, the host processor may be configured with processor-executable instructions to perform operations such that maximizing the touch resolution in response to an “active” setting includes separating rows in the touchscreen area, separating columns in the touchscreen area, adjusting a drive strength of an electronic signal sent through the touchscreen area to allow for scanning individual rows and columns, and performing future scans of the touchscreen area for touches on individual rows and individual columns. In a further aspect, the host processor may be configured with processor-executable instructions to perform operations such that setting the mid-range touch resolution in response to a “semi-active” setting includes aggregating a plurality of rows in the touchscreen area, aggregating a plurality of columns in the touchscreen area, adjusting a drive strength of a electronic signal sent through the touchscreen area to allow for scanning the aggregated rows and aggregated columns, and performing future scans of the touchscreen area for touches on the aggregated rows and the aggregated columns, in which the plurality of rows may be less than a total number of rows of the touchscreen panel, and the plurality of columns may be less than a total number of columns of the touchscreen panel. In a further aspect, the host processor may be configured with processor-executable instructions to perform operations further comprising such that disabling the touchscreen panel in response to a “sleep” setting includes disabling the touchscreen area, reducing a drive strength of a electronic signal sent through the touchscreen area to allow for no scanning and not performing scans of the touchscreen area.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1A is a component block diagram of a touchscreen computing device suitable for use with the various aspects.

FIG. 1B is a component block diagram of a touch signal data path suitable for use with the various aspects.

FIG. 2 is a process flow diagram illustrating an aspect method for processing a touch signal, calibrating touch signals, and updating a touch-processing state and touchscreen-scanning setting.

FIG. 3A is an aspect call flow relationship between a transducer front end and a touchscreen controller, a touchscreen controller and a host processor, and a transducer front end and a host processor.

FIG. 3B is another aspect call flow relationship between a transducer front end and a touchscreen controller, a touchscreen controller and a host processor, and a transducer front end and a host processor.

FIG. 3C is an aspect call flow relationship between a transducer front end and a host processor.

FIG. 4A is a process flow diagram illustrating an aspect method for updating a touch-processing state by utilizing touch determinations from a touchscreen controller and a host processor.

FIG. 4B is a process flow diagram illustrating another aspect method for updating a touch-processing state by utilizing touch determinations from a touchscreen controller and a host processor.

FIG. 4C is a process flow diagram illustrating an aspect method for updating a touch-processing state by utilizing touch determinations from a host processor.

FIG. 5 is a state diagram illustrating an aspect method for transitioning between touch-processing states.

FIG. 6 is a process flow diagram illustrating an aspect method for selecting an appropriate touch-processing state based on the presence or absence of a touch signal.

FIG. 7 is a component block diagram of an analog front end suitable for use with the various aspects.

FIGS. 8A through 8D are component diagrams of a portion of a conductive touch pad or touchscreen panel according to four aspects of touchscreen scanning settings.

FIG. 9 is a process flow diagram illustrating an aspect method for setting the touchscreen scanning setting based on the touch-processing state.

FIG. 10 is a component block diagram of a signal processing data path for a touch signal.

FIG. 11 is a process flow diagram illustrating an aspect method for processing a touch signal on a host processor.

FIG. 12 is a component block diagram of a transducer front end according to an aspect.

FIG. 13 is a process flow diagram illustrating an aspect method for calibrating a transducer front end.

FIG. 14 is a process flow diagram illustrating an aspect method for generating calibration parameters by a host processor for use by a transducer front end.

FIG. 15 is a process flow diagram illustrating an aspect method for calibrating a touchscreen controller with calibration parameters generated by a host processor.

FIG. 16 is a component block diagram of an example wireless tablet device suitable for use with the various aspects.

FIG. 17 is a component block diagram of an example wireless mobile computing device suitable for use with the various aspects.

FIG. 18 is a component block diagram of another example wireless mobile computing device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “touchscreen computing device,” refers to any one or all of cellular telephones, tablet computers, personal data assistants (PDAs), palm-top computers, notebook computers, laptop computers, personal computers, wireless electronic mail receivers and cellular telephone receivers (e.g., the Blackberry® and Treo® devices), multimedia Internet enabled cellular telephones (e.g., Blackberry Storm®), multimedia enabled smartphones (e.g., Android® and Apple iPhone®), and similar electronic devices that include a programmable processor, memory, a communication transceiver, a display, and a touchscreen for receiving touch input.

As used herein, the term “host processor” refers to a processor operating on a touchscreen computing device that is configured to run applications and/or the operating system of the computing device. The host processor may receive information from and send tasks for completion to other, peripheral processors, such as a digital signal processor or a touchscreen controller, which are special purpose processors configured to perform specialized operations.

Touchscreen displays and touchscreen panels are becoming one of the most common forms of user interfaces for computing devices, especially mobile devices. Touchscreen displays and panels are configured to detect a user's touch (such as by a finger tip or a special pointer tip) on the display, and generate signals which may be processed by a touchscreen controller to recognize the location on the display of the touch. The touch location information is then processed by user interface software as a user input to the touchscreen computing device. For ease of reference, user touches on a touchscreen panel are referred to herein as “touch inputs,” touch inputs that are not noise are referred to herein as “valid touch inputs,” the signals generated by a touchscreen transducer in response to a user's touch are referred to herein as “touch signals,” and the information contained within touchscreen touch inputs (i.e., the raw data generated by the touchscreen circuits) is referred to herein as “touch signal data.”

A touchscreen computing device may comprise, among other things, a touchscreen sensor for receiving a user's input, a transducer for converting a touch into a touch signal, a specialized touchscreen controller processor, a multi-core application-processor subsystem (i.e., a host processor), and a display. The various aspects may work with any of a variety of touchscreen devices, including capacitive sensing screens, resistance sensing screens, and combinations thereof. Regardless of the touch sensing technology, the touchscreen sensor may detect a touch in terms of screen coordinates (e.g., rows and columns) when a user's touch affects the electrical properties of the screen in a small region. The function performed by the touchscreen controller in a conventional touchscreen, and by the host processor in the various aspects, is to translate the electrical signals generated by the touchscreen into a form that the host processor can interpret as a user input, such as the location of the touch on the touchscreen.

Current touchscreen controllers independently detect users' touches and may request a host processor perform its share of processing only after the touchscreen controller detects a touch, even if that touch is invalid (e.g., accidentally touching a touchscreen with the palm of the hand). When a touchscreen controller does not detect a touch, a host processor may remain inactive. However, because of the touchscreen controller's increasing inability to detect multiple touches, the touchscreen controller may interrupt a host processor to report a false touch, thereby minimizing battery life, or may not report a touch that has occurred at all, thereby reducing responsiveness to a user's touches. Therefore, there is a need for a host processor to concurrently process touch signals to determine whether the touch signal data is noise.

In general, noise may be information received by touch sensors at the touchscreen panel that does not represent valid user touch inputs. For example, noise may be errant or useless information reported by touch sensors. Noise (or noise data) may be information detected and reported by a touchscreen panel that is errata, invalid, or otherwise not useful to applications being executed by a host processor. Noise may alternatively be characterized as false positive data that is similar to information useable by applications, but that is unintended by the user, generated by electrical noise and/or otherwise errant. The touchscreen controller and the host processor may employ a processor or circuit configured to evaluate touch signal data to determine whether it is noise. For example, a touchscreen controller subsystem or a host processing system may include a noise analysis component. Determining whether touch signal data is noise may be important in conserving power and improved performance. For example, when touch signal data is determined to be noise, the touchscreen controller and the host processor may jointly determine whether to ignore the data and not perform operations to determine touch signal data complexity, thereby avoiding needlessly processing touch signals.

Ambient noise may be information reported by touchscreen panel touch sensors that does not correspond to an actual touch input performed by the user. In an aspect, ambient noise may be reported by touchscreen panel touch sensors based on poor grounding of the user or particulates within the atmosphere. For example, touch sensors of a projected capacitive touchscreen computing device may report noise (e.g., from capacitance changes) due to moisture particles in the air around the touchscreen panel. The touchscreen controller and the host processor may concurrently determine whether the touch signal data is ambient noise based on similarities between the touch signal data and predetermined data patterns (e.g., constant, low levels of wide-spanning touch signal data may be regarded as ambient noise), evaluations of the touch signal data's strength (e.g., the input data may represented by faint signals), and other touch signal data characteristics that indicate randomness and/or the lack of actual human interaction with the touchscreen panel (e.g., the touch signal data does not correspond to valid touch inputs).

In general, false-touch noise may describe touch inputs on the touchscreen panel that were not likely intended to correspond to user input for an application executing on the touchscreen computing device. For example, when the user pulls a tablet touchscreen computing device out of a bag, he/she may place all of his/her hand on the touchscreen panel, causing a false touch. In an aspect, the touchscreen controller may recognize false-touch noise by comparing the touch signal data to normalized touch signal data over time. For example, the touchscreen controller may compare the region of the touchscreen panel involved in the current touch signal data to the typical (or normalized) surface area related to previous touch signal data. When the touch signal data does not match (or is not within a tolerance threshold of similarity) to previous valid touch signal data, the touchscreen controller determines that the touch signal data is false-touch noise.

Static-touch noise may occur when the user picks-up his/her touchscreen computing device (e.g., a smartphone) and the user's finger remains in contact with a single location of the touchscreen panel for a period of time. The touchscreen controller may recognize static-touch noise by evaluating the duration that touch signal data remains unchanged. In an aspect, if touch signal data represents a touch input at a constant location in excess of a predefined period, the touchscreen controller may disregard the touch signal data corresponding to the location as static-touch noise.

In another aspect, the touchscreen controller and the host processor may utilize various stored data patterns of known noise data. For example, the host processor may compare the touch signal data to information within a database of known noise data patterns, and if there is a match, the touch signal data may be disregarded as noise.

For ease of reference, any noise—including ambient noise, false-touch noise, static-touch noise, and any other type of noise without limitation—will be referred to herein as “noise.” For example, if a host processor determines that a touch signal is noise, the touch signal may represent any combination of noise types without limitation.

In various aspects, a host processor and a touchscreen controller may concurrently receive and process touch signals to determine whether the touch input indicated by the touch signal is noise or a valid touch input and, therefore, whether the touch signal should be further processed. In an aspect, a touchscreen controller may independently receive touch signals from a transducer front end and may use those touch signal to determine whether the touchscreen panel received a valid touch input. A host processor may also independently receive a touch signal from a touchscreen transducer and determine whether the touchscreen panel received a valid touch input. In a further aspect, the host processor may receive the touchscreen controller's determination of whether a valid touch input was received and use that determination when independently deciding whether a valid touch input was received on the touchscreen panel. If the host processor determines that a valid touch input was received, the host processor may further process the touch signal. Otherwise, the host processor may not further process the touch signal. In another aspect, the host processor may process the signal when it determines that a valid touch input occurred, regardless of the touchscreen controller's determination.

In various aspects, a host processor and a touchscreen controller may collaborate to set the touch-processing state based on the current valid touch input activity (i.e., how recently valid touch inputs have occurred). In various aspects, the touch-processing state may correspond to three states: “active,” “standby,” and “sleep.”

In some aspects, the host processor may determine and set the appropriate touch-processing state. The touchscreen controller may supervise the touch-processing state and manage the touchscreen's scanning parameters. The host processor may use its superior processing capabilities to process the touch signal while the touchscreen controller may forego processing touch signals and instead focus on communicating instructions to the touchscreen sensor (e.g., what scan rate should be used for a given touch-processing state, like “standby”). In another aspect, the host processor may directly communicate instructions to the touchscreen sensor. In other aspects, a touchscreen controller and a host processor may jointly determine the touch-processing state.

In various aspects, the touch-processing state may be used to set the touchscreen-scanning setting. For example, if the touch-processing state is “active,” the touchscreen controller may cause the touchscreen to scan at maximum resolution. In other words, the touchscreen controller may instruct the touchscreen to scan for touch inputs one row at a time, thereby allowing for the detection of a specific touch input location. If the state is not “active,” but rather “standby,” the touchscreen controller may instruct the touchscreen to minimize its resolution and may increase the screen drive strength accordingly. For example, the touchscreen may aggregate its rows and columns (i.e., scan multiple rows and/or columns at a time) to decrease touch sensitivity such that the touchscreen may be able to detect the existence of a touch input but not the specific location. By having the touchscreen minimize its resolution, the touchscreen computing device may save energy and minimize the response-time for detecting a touch input. Once a touch input is detected during “standby,” the touchscreen computing device may quickly change the touch-processing state to reflect that the touch-processing state is now “active.” If the touch-processing state is not “standby” or “active,” the touchscreen may be disabled (i.e., “sleep”) until, for example, the user pushes the power button on the device, which may change the touch-processing state to “active.” In another aspect, the touchscreen-scanning settings may be set to only scan certain areas of the touchscreen panel, and each of these areas may have a different touchscreen-scanning setting. For example, the host processor may restrict “active” scans on the touchscreen panel to areas that correspond to a button rendered on a display panel.

In various aspects, a host processor may receive touch signals directly from a transducer front end. The host processor may also process the touch signals to determine whether a valid touch input was received. The host processor may further process the touch signals to transform the touch signals into a form useable by applications and other components of the touchscreen computing device, including detecting primitive touch and gesture recognition.

In various aspects, a host processor may be configured to calibrate a touch signal that a transducer front end generates from a touch input into a form that the host processor may use. For example, a host processor may receive a noisy touch signal from the transducer front end and may instruct the transducer front end to modify how it generates signals in the future. In another aspect, a touchscreen controller may receive calibration parameters from a host processor and use those calibration parameters to configure a transducer front end to generate calibrated touch signals that the host processor may directly use.

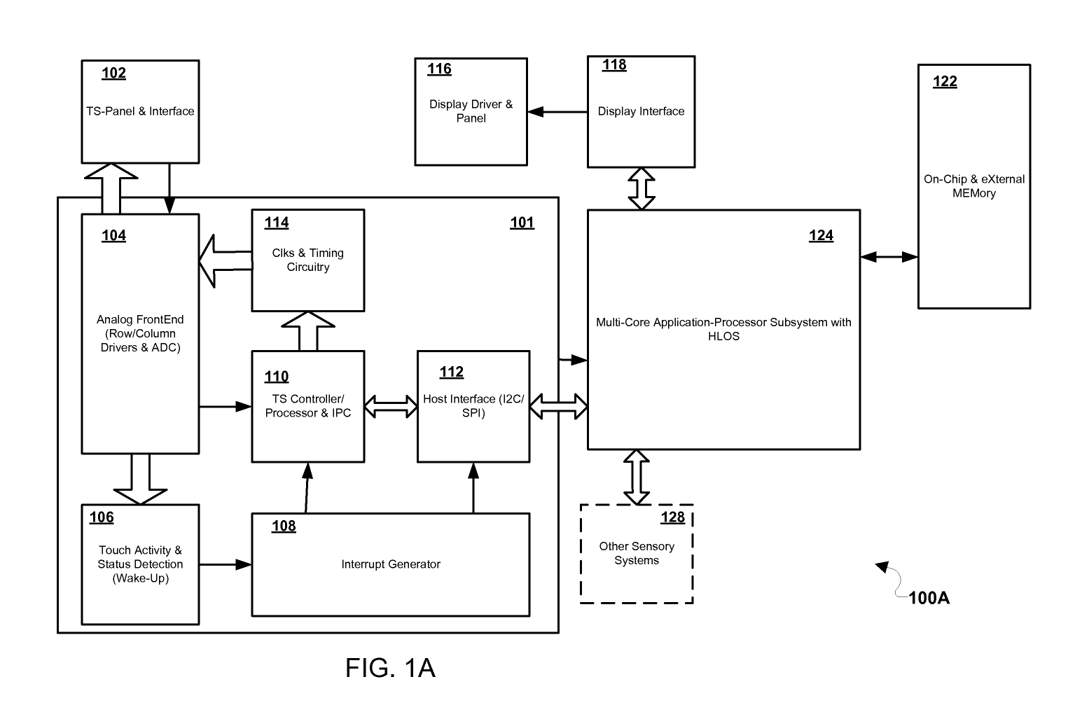

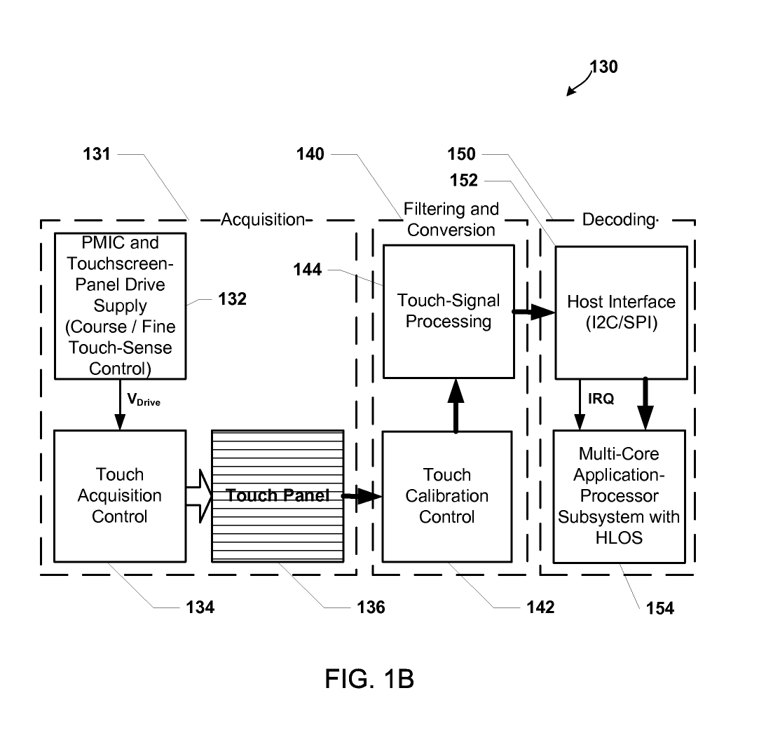

FIGS. 1A-1B illustrate a typical touch signal data path. FIG. 1A is a component block diagram of a touchscreen computing device 100 suitable for use with the various aspects. A touchscreen computing device 100 may be any computing device that is connected to or contains a touchscreen panel 102 or otherwise receives touch inputs for processing. For example, touchscreen computing devices 100 may include smartphones, tablet devices, gaming devices (e.g., Nintendo DS, Nintendo 3DS, Sony Vita, etc.), etc. As another example, a smart-TV having a connected touchscreen peripheral device may also be a touchscreen computing device 100. The touchscreen panel 102 may be an interface for receiving user touch inputs based on detected tactile (or near tactile) interactions. For example, a user may use fingers, stylus, or other physical implements to touch and thereby provide the touchscreen panel 102 with a touch input. Touchscreen panels 102 and interfaces may include touch sensors and may be implemented to utilize various touch-sensing techniques, such as resistive, surface capacitive, projected capacitive, infrared, surface-acoustic-wave, strain gauge, optical imaging, dispersive-signal-technology, etc. For example, a resistive touchscreen panel 102 may detect touch inputs based upon detecting a physical depression on a surface caused by a user's finger on the touchscreen panel 102.

The touchscreen computing device 100 may include a touchscreen controller subsystem 101 that includes circuits configured to receive and process touchscreen touch inputs, included touch signal data, from the touchscreen panel 102. For example, the touchscreen controller subsystem 101 may include an analog front end circuit 104 that may receive analog signals corresponding to detected touch inputs on the touchscreen panel 102, and may utilize row and column drivers and/or other components, such as multiplexors, to categorize, combine, and/or otherwise turn the received signals into processable data.

In response to receiving touchscreen touch inputs, the analog front end circuit 104 may transmit received touchscreen touch inputs to a touch activity detection component 106 that may be configured to determine whether the touchscreen panel 102 has encountered touch inputs (e.g., whether there is touchscreen panel 102 activity). In an aspect, the touch activity detection component 106 may determine activity based on evaluating and differentiating temporal averages of reported touchscreen touch inputs. For example, stored information received over a period of time may be evaluated to determine whether received touchscreen touch inputs describe activity or are errata. The touch activity detection component 106 may also communicate with an interrupt generator 108 that may transmit interrupt signals to the touchscreen controller 110. For example, when a touch input is detected on the touchscreen panel 102 while the touchscreen controller 110 is configured to be in a sleep state or mode, the interrupt generator 108 may send interrupt signals indicating that the touchscreen controller 110 should wake or that there is touch signal data available for processing. In an aspect, the interrupt generator 108 may produce signals received by a host processor 124.

The analog front end circuit 104 may additionally deliver touchscreen touch inputs to the touchscreen controller 110. In an aspect, the analog front end circuit 104 may alternatively deliver other signals that represent the touch signal data related to touch inputs detected on the touchscreen panel 102. For example, the analog front end circuit 104 may process received touchscreen touch inputs and transmit a data signal containing touch signal data to the touchscreen controller 110 in general the touchscreen controller 110 is a processing unit that processes touch signal data and provides user input commands or data to the device processor in a form that can be processed by the operating system and/or applications as user inputs. As discussed above, the touchscreen controller 110 may also determine whether touch signal data represents valid information requiring processing (e.g., valid touch signal data as opposed to noise). For example, the touchscreen controller 110 may evaluate touchscreen touch inputs to determine whether included touch signal data represents useless noise. The touchscreen controller 110 may utilize a clock or timing circuitry 114 and may transmit commands to the analog front end circuit 104 based on information maintained by the clock or timing circuitry 114.

The touchscreen controller subsystem 101 may also include a host interface 112 that enables the touchscreen controller 110 to transmit user input data (e.g., the location on the touchscreen of a user touch) to the host processor 124. The host interface 112 may utilize system component communication protocols, such as an inter-integrated circuit (I2C) protocol and/or a serial peripheral interface (SPI) protocol. Additionally but not shown, the touchscreen controller subsystem 101 may include a quantizer component, a horizontal integrator component, and a vertical integrator component which may be controlled by the touchscreen controller 110 and may scale touchscreen touch input and/or touch signal data to various resolutions. For example, touchscreen touch inputs may be scaled down in resolution to increase the efficiency at which the touchscreen controller 110 may process related touch signal data. Also not shown, the touchscreen controller subsystem 101 may further include components for tracking and/or holding touchscreen touch inputs (i.e., binning control) that may spatially integrate touchscreen touch inputs and enable the touchscreen computing device 100 to reduce scan rates related to detecting touch inputs.

The host processor 124 may be a multi-core host processor that may be distinct from the touchscreen controller 110. The host processor 124 may be any of a variety of programmable processors capable of running applications and an operating system for managing such applications. For example, the host processor 124 may persistently execute a high level operating system (HLOS) that may perform numerous routines to utilize the components and software of the touchscreen computing device 100. The host processor 124 may also store data within and retrieve data from a memory component 122 that may be external and/or on-chip memory.

The touchscreen computing device 100 may further include a display panel 116 (and associated drivers) configured to render various imagery. For example, the display panel 116 may be an LCD display capable of displaying a graphical user interface (GUI) for an application being executed on the host processor 124. The host processor 124 may control the display panel 116 by transmitting data via a display interface 118 component which may translate or process data for rendering by the display panel 116.

The host processor 124 may receive data from the touchscreen controller 110 capable of being utilized by the various applications executed on the host processor 124. In an aspect, the host processor 124 may configured to receive touchscreen touch inputs and/or touch signal data directly from the touchscreen controller subsystem 101 to enable the processor to process touch signal data. For example, the touchscreen computing device 100 may include a data path that directs raw touchscreen touch inputs to the host processor 124. In an optional aspect, the host processor 124 may be coupled to other sensors 128, such as accelerometers.

The touchscreen computing device 100 may also include other components not shown in FIG. 1, such as application data movers for transferring various data from the host processor 124, a graphic processing unit (GPU) that process and generate data related to multimedia, and display-processors and/or controllers that may communicate display commands from the host processor 124 to the display interface 118.

FIG. 1B illustrates an aspect touch signal data path system 130 for use with the various aspects. A touch signal data path system 130 may include three distinct phases: an acquisition phase 131, a filtering and conversion phase 140, and a decoding phase 150. In an acquisition phase 131, a power management integrated circuit (PMIC) and a touchscreen-panel drive supply module 132 may supply voltage to a touch acquisition control module 134. The touch acquisition control module 134 may be configured to regulate the scanning rate and resolution of and to drive voltage through a touchscreen panel 136. The touchscreen panel 136 may be configured to output a touch signal based on a touch input. In a projective capacitive touchscreen, the touchscreen panel 136 may have rows and columns of conductive materials that form a grid. The rows may be switchably connected to a voltage source, and the columns may be switchably connected to an electronic sensor. The electronic sensor may be able to detect changes in voltage, which may correspond with a touch input, and may generate an analog touch signal that is converted to a digital touch signal during the filtering and conversion phase 140.

The touchscreen panel 136 may be configured to send the analog touch signal to a touch calibration control module 142, where the analog touch signal is converted to a digital touch signal and calibrated. The touch calibration control module 142 may be configured to analyze the digital touch signal to determine whether the touchscreen panel 136 has detected a valid touch input or noise. The digital touch signal may be sent to a touch-signal processing module 144. The touch-signal processing module 144 may be configured to process the digital touch signal using various methods, including applying gains, enhancing the signal-to-noise ratio, de-noising the signal, and other touch processing techniques.

The digital touch signal may pass to a host interface 152 as part of the decoding phase 150. In an aspect, the host interface 152 may be an inter-integrated circuit or a serial peripheral interface. The host interface 152 may be configured to act as a conduit to the multi-core application-processor subsystem with a high-level operating system (i.e., the host processor 154). The host interface 152 may be configured to send an interrupt signal to the host processor 154 when the host processor is not active to alert the host processor 154 that a touch signal is available for further processing. Otherwise, if the host processor 154 is “awake” and available to receive a touch signal, the host interface 152 may directly send the touch signal to the host processor 154 without sending an interrupt signal. The host processor 154 may perform additional decoding and processing on the touch signal to transform the digital touch signal into a form usable by applications or other components of the touchscreen computing device.

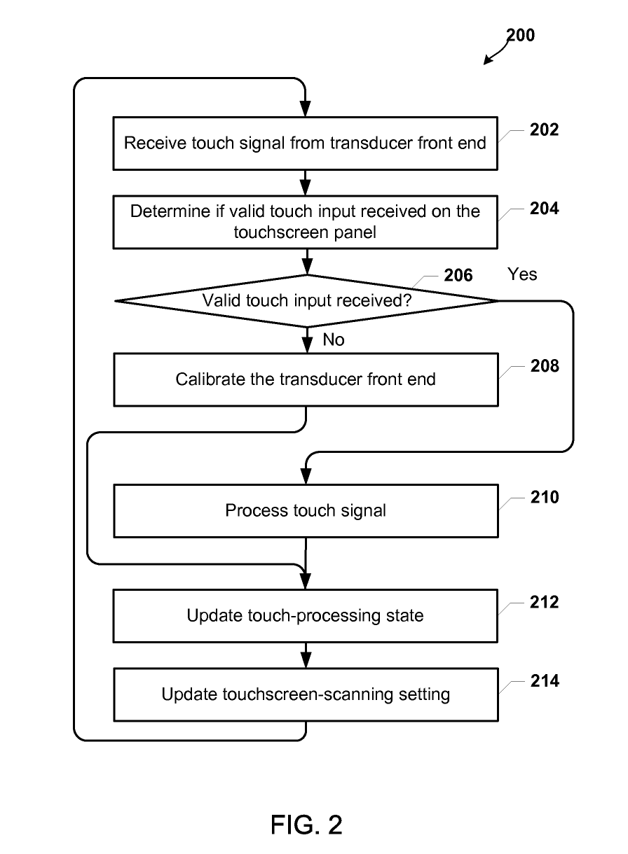

FIG. 2 illustrates an aspect touchscreen computing device method 200 for calibrating a touch signal received from a transducer front end, processing the touch signal, and updating a touch-processing state and corresponding touchscreen-scanning setting. For ease of reference, a host processor will be used to describe the actions of method 200. As will be appreciated by one of skill in the art, one or more processors, including a touchscreen controller, may perform any or all of method 200.

In block 202, a host processor may receive a touch signal from a transducer front end. In an aspect, a touch signal may be sent directly from the transducer front end and calibrated into a form that a host processor may use. The transducer front end may generate the touch signal in response to a touch input received on the touchscreen panel. The host processor may determine whether a valid touch input was received on the touchscreen panel in block 204 and determination block 206. For example, the host processor may apply various signal processing techniques (e.g., de-noising, applying gains, and other signal enhancement) to decide whether the touch input is just noise. Additionally, the host processor may retrieve additional contextual information about the touch input from various sensors and applications that may be operating on the touchscreen computing device. This additional contextual information may indicate that a valid touch input is more or less likely. In an example, the host processor may learn from an application that the touch input corresponded to a location on the display where a button is rendered and that the application expected a touch input to be received at that location.

If a valid touch input was received (i.e., determination block 206=“Yes”), the host processor may further process the touch signal in block 210. This further processing may put the touch signal in a form that is usable by applications and other components operating on the touchscreen computing device. If a valid touch input is not received (i.e., determination block 206=“No”), in block 208 the host processor may calibrate the transducer front end. For example, if a transducer front end repeatedly reports that a touch input occurred after scanning a particular row on the touchscreen panel, but the host processor determines that no touch input has occurred at that location, the host processor may send the transducer front end instructions to skew scan results from that row to avoid reporting the same kind of noise in the future.

In block 212, the host processor may update the touch-processing state. The touch-processing state is a measure of valid-touch-input activity on the touchscreen panel. For example, if the touchscreen panel is currently receiving valid touch input, the touch-processing state may be set to “active.” Other examples of touch-processing states include “standby,” which may be appropriate when there has not be a valid touch input for a given period of time, and “sleep,” which may be appropriate when there has not be a valid touch input for an even longer period of time.

The host processor may then update the touchscreen-scanning setting in block 214. The touchscreen-scanning setting may direct how the touchscreen panel is scanned. For example, if the touch-processing setting is “active,” the host processor may update the touchscreen-scanning settings to “active,” which may cause the touchscreen panel to be scanned at a maximum resolution (i.e., the touchscreen panel may be able to detect precise touch input coordinates). In another example, the host processor may update the touchscreen-scanning settings to “standby” when the touch-processing state indicates that no valid touch-input has occurred for a given period of time. In this touchscreen-scanning setting, the touchscreen panel may be scanned at a minimum resolution (i.e., the entire touchscreen panel is scanned at one time, indicating a touch input occurred but not its location). The host processor may also continue operating in block 202.

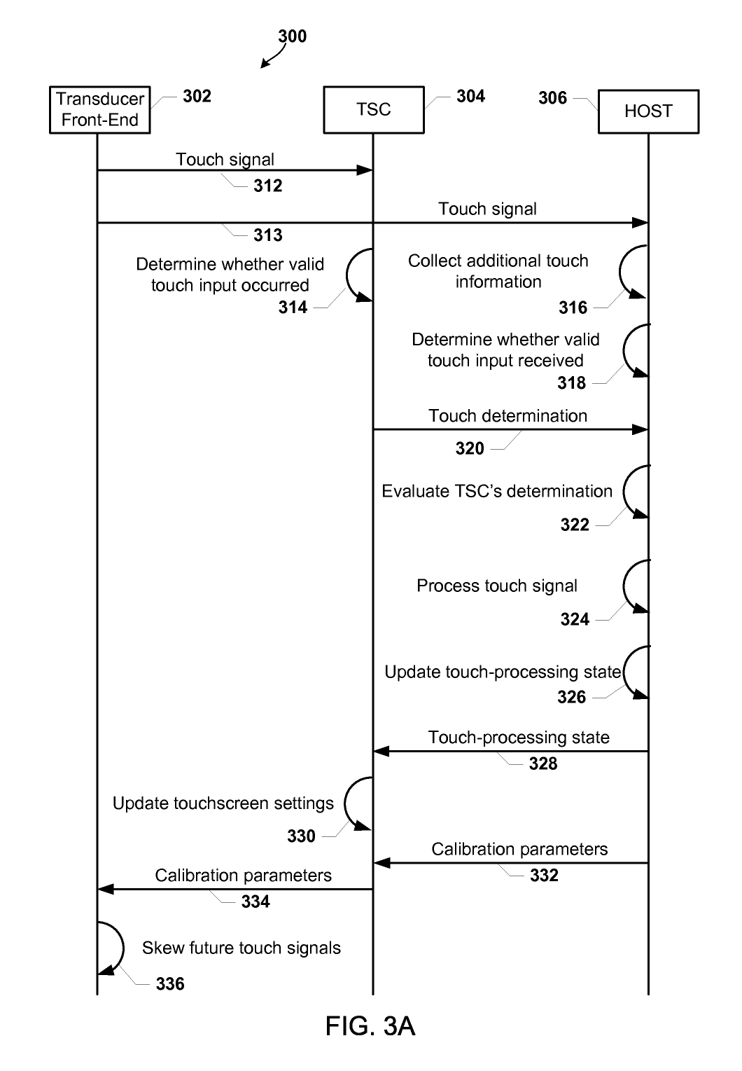

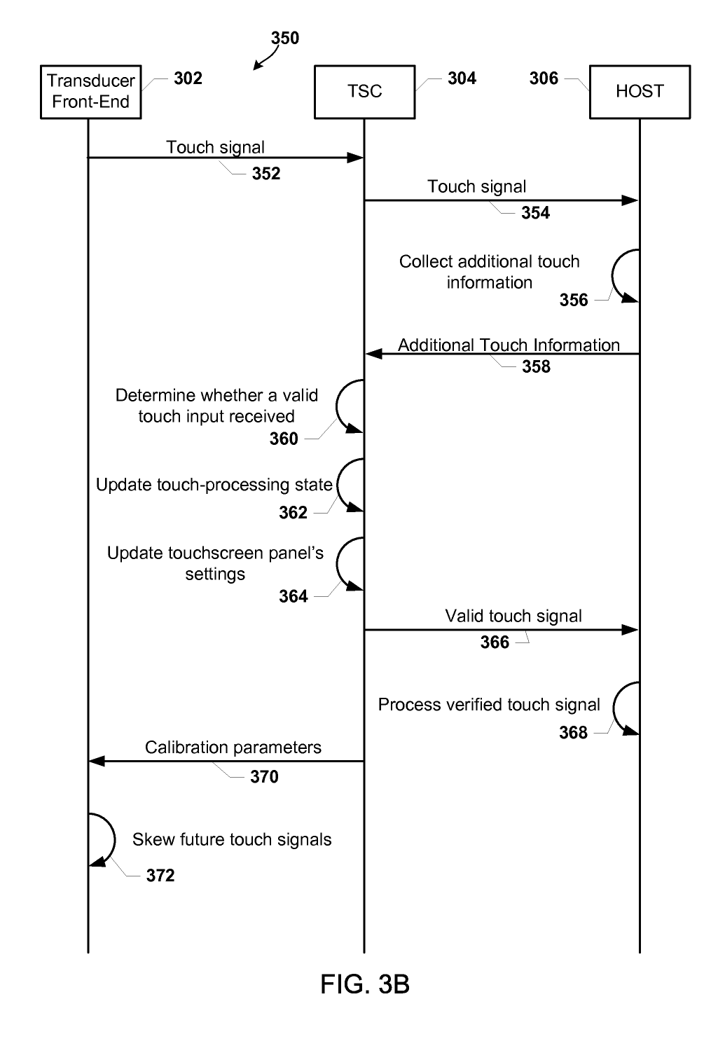

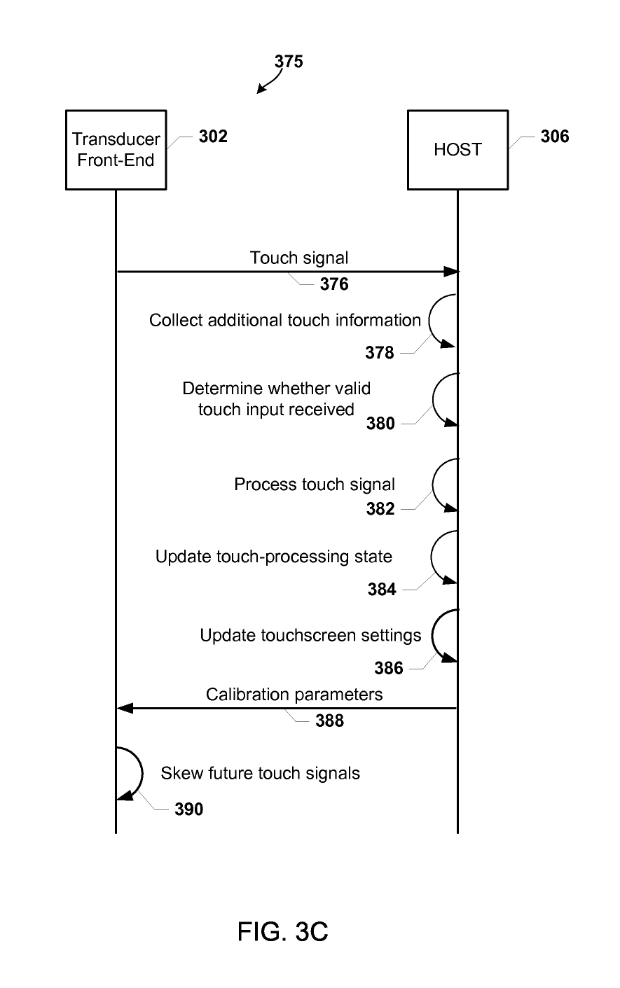

FIGS. 3A-3C illustrate signaling and call flows for various aspects. FIG. 3A illustrates signaling and call flows 300 among a transducer front end, a touchscreen controller, and a host processor. A transducer front end 302 may transmit a touch signal 312 to a touchscreen controller 304 (referred to in FIG. 3A as “TSC”). The transducer front end 302 may also send the same touch signal to a host processor 306 in the form of a touch signal 313. The touchscreen controller 304 may process the touch signal 312 in operation 314 to determine whether a valid touch input occurred. The touchscreen controller 304 may, for example, perform de-noising and signal enhancements. The host processor 306 may collect additional touch information in operation 316 regarding the touch signal 313 from applications and/or other sensors operating on the touchscreen computing device. For example, the host processor 306 may learn from applications that the touch input occurred in an area in which a touch was not expected. After accumulating additional context information, the host processor 306 may determine in operation 318 whether a valid touch input was received. For example, the host processor 306 may process the touch signal 313 by de-noising and enhancing the signal and evaluate the touch signal 313 in light of the additional touch information gathered in operation 316. The touchscreen controller 304 may send its touch determination 320 of whether the touch signal data indicates a valid touch input to the host processor 306.

In operation 322, the host processor 306 may evaluate the touch determination received from the touchscreen controller 304. For example, the host processor 306 may compare its own touch determination with the touchscreen controller 304's touch determination and evaluate whether the touchscreen controller's touch determination reveals additional information that might indicate that a valid touch input was more or less probable. Upon determining that the touch signal data indicates a valid touch input, the host processor 306 may process the touch signal in operation 324 by decoding the touch signal and transforming it into a useful form for applications operating on the touchscreen computing device.

The host processor 306 may then update the touch-processing state in operation 326 in response to the host processor 306's final determination as to whether a valid touch input was received. For example, if the host processor 306 ultimately concludes that a valid touch input occurred, the host processor 306 may set the touch-processing state to “active.” Otherwise (i.e., there was no valid touch input received), the host processor 306 may change or not change the processing state depending on various factors, including the time interval between the most recent touch signal and the latest valid touch input.

In an aspect, the host processor 306 may send the touch-processing state 328 to the touchscreen controller 304 with instructions to implement the touch-processing state. In a further aspect, the touchscreen controller 304 may change the touchscreen settings in operation 330 to reflect the updated touchscreen processing state. For example, if the touchscreen is currently set to “standby,” wherein the touchscreen's scanning resolution is minimal, the touchscreen controller 304 may change the touchscreen's setting to “active,” wherein the touchscreen's scanning resolution is set to the maximum, to reflect the new touch-processing state.

In another aspect, the host processor 306 may send calibration parameters 332 to the touchscreen controller 304 that may correct the touchscreen controller's future touch determinations. These calibration parameters 332 may instruct the touchscreen controller that its touch determination was erroneous and to avoid reporting similar invalid touch inputs in the future.

In a further aspect, the touchscreen controller 304 may transmit calibration parameters 334 to the transducer front end 302 to calibrate future touch signals that the transducer front end 302 generates. For example, if, over time, the touchscreen controller discovers, either independently or in conjunction with a host processor, that touch signals from scans of the same row on the touchscreen consistently and erroneously indicate that a touch input occurred, the touch screen controller may give the transducer front end instructions to skew future scans of the faulty row to eliminate noise. The transducer may implement those instructions in operation 336.

FIG. 3B illustrates another aspect of signaling and call flows 350 among a transducer front end 302, a touchscreen controller 304, and a host processor 306. In this aspect, a touchscreen controller 304 (referred to in FIG. 3B as “TSC”) may primarily be responsible for determining and updating the touch-processing state, and a host processor 306 may support the touchscreen controller 304 by sending contextual information discerned from the touch signal data that may better allow the touchscreen controller 304 to determine whether a valid touch input was received on the touchscreen panel.

A transducer front end may generate a touch signal 352 from a touch input on a touchscreen panel and may send the touch signal 352 to a touchscreen controller 304. The touchscreen controller 304 may transmit the touch signal 352 to a host processor 306 as touch signal 354. The host processor 306 may collect additional touch information in operation 356 as described above in FIG. 3A. This information may come from data the host processor 306 receives from sensors or applications operating on the touchscreen computing device. For example, the host processor 306 may query an application that has graphics rendered on the display to discover if there is a user-interface graphic (e.g., a button) rendered at the location indicated by the touch signal 354. In a further example, if a button is rendered at the touch location, the host processor 306 may be able to determine that there is a higher likelihood that a touch actually occurred because the application expects a user to interact with the button through a touch input. The host processor 306 may send this additional touch information 358 to the touchscreen controller 304.

After receiving the host processor's additional touch information 358, the touchscreen controller may determine whether a valid touch input was received in operation 360. The touchscreen controller may perform apply various signal processing techniques on the touch signal 352, such as de-noising or applying gains to enhance the signal-to-noise ratio. The touchscreen controller may incorporate the additional touch information 358 from the host processor to further determine whether the touchscreen panel received a valid touch input. For example, if the touchscreen controller 304 determines that a touch occurred after de-noising and amplifying the touch signal, the touchscreen controller may ultimately determine that no touch occurred because the additional touch information 358 indicates a very low probability that the touchscreen received a valid touch input. For example, the touch signal may indicate that the touchscreen panel received a touch input at a location that was not expected (e.g., there was no button there or the touch input occurred on the edge of the touchscreen panel).

Once the touchscreen controller 304 determines whether the touchscreen panel received a valid touch input in operation 360, the touchscreen controller 304 may update the touch-processing state in operation 362. As discussed above, the touch-processing state relates to current touch input activity. For example, if the touchscreen panel is presently receiving valid touch inputs or presently expects valid touch inputs, the touch-processing state may be set to “active.” In another example, if the touchscreen has not received a valid touch input for a threshold amount of time, the touch-processing state may be set to “standby” or “sleep,” when appropriate.

After setting the touch-processing state, the touchscreen controller 304 may update the touchscreen's settings to reflect the touch-processing state in operation 364. For example, if the touch-processing state is set to “standby,” the touchscreen controller 304 may set the touchscreen's setting from “active” to “standby.” In this case, the touchscreen's scanning resolution may be changed from a maximum resolution (i.e., “active”) to a minimum resolution (i.e., “standby”).

Once the touchscreen controller 304 updates the touchscreen's settings in operation 364 to reflect the updated touch-processing state, the touchscreen controller 304 may send a valid touch signal 366 to the host processor 306. The host processor 306 may further process the valid touch signal 366 in operation 368. For example, the host processor 306 may process the valid touch signal 366 into a form usable by applications currently running on the touchscreen computing device. In a further example, the host processor 306 may transform the verified touch signal into data that an application may use to know that a particular button was touched and, to compute the appropriate response to the user's touching the button. In yet another example, the host processor 306 may be configured to process a valid touch signal to recognize touch gestures, such as a flick or a pinch. The host processor 306 may also send this gesture information to applications.

In a further aspect, the touchscreen controller 304 may create calibration parameters 370 for the transducer front end based on its touch determination. The transducer front end 302 may receive the calibration parameters 370. The transducer front end 302 may skew future touch signals in operation 372. The transducer front end 302 may accomplish this skewing/correction by incorporating the touchscreen controller's calibration parameters 370. For example, if the transducer repeatedly sent the touchscreen controller a touch signal 352 that was noise, the touchscreen controller 304 may send instructions to the transducer front end 302 to skew future touch signals to reduce or avoid sending similar noisy signals.

FIG. 3C illustrates signaling and call flows 375 between a transducer front end 302 and a host processor 306. In this aspect, a transducer front end 302 communicates directly with a host processor 306, and the touchscreen computing device does not utilize a touchscreen controller 304 for detecting touches and processing touch signals. Instead, the host processor 306 may perform all of the actions and processing that the touchscreen controller 304 would otherwise have performed.

As discussed above, a transducer front end 302 may generate a touch signal 376 from a touch input on a touchscreen panel. The transducer front end 302 may directly send the touch signal 376 to a host processor 306. The host processor 306 may collect additional touch information from sensors and applications operating on the touchscreen computing device in operation 378 as described above with reference to FIGS. 3A-3B. From these sensors and applications, the host processor 306 may be able to determine, for example, whether an object or graphic which the user may interact is currently being rendered on the display at the location in which the touchscreen panel received a touch input. In a further example, the host processor 306 may determine that a touch input occurred at a location on the touchscreen panel where an application rendered a soft QWERTY keyboard on the display. In another example, the host processor 306 may determine that a touch input occurred at a location where nothing is rendered and no touch input is expected, such as on the boarder or a corner of the touchscreen panel. The activity occurring at the location associated with the touch signal may thereby indicate a higher or lower likelihood of a touch actually occurring.

In another example, the host processor 306 may receive information from other sensors, including photographic sensors (e.g., cameras and ambient light sensors), accelerometers, gyroscopes, and proximity sensors. These additional sensors may provide information to the host processor 306 that may further indicate whether a valid touch input likely occurred. For example, the accelerometer sensor may detect that the touchscreen computing device is being or has recently been moved or rotated, which may indicate a higher likelihood of touch. In another aspect, the host processor 306 may additionally receive information from applications running on the touchscreen computing device. For example, the host processor may be notified that the user is watching a movie on the touchscreen computing device, which may decrease the likelihood that a signal corresponds to a valid touch. As another example, the host processor may be notified that the user is playing a game involving rapidly tapping the touchscreen, which may increase the likelihood that a signal corresponds to a valid touch.

The host processor may also perform some preliminary processing of the touch signal 376. The host processor 306 may, for example, perform signal de-noising, apply gains to increase the signal-to-noise ratio, and various other techniques to correct or enhance the touch signal 376. By removing noise, the host processor 306 may better estimate whether the touch signal 376 represents a valid touch input.

After collecting additional touch information in operation 378 and enhancing the signal, the host processor may be able to determine whether a valid touch input actually occurred in operation 380. If the host processor 306 determines that the touchscreen panel received a valid touch input, the host processor 306 may process the touch signal in operation 382 into a form usable by processes or applications running on the touchscreen computing device. In operation 384, the host process may also update the touch-processing state, which as mentioned above, is the status of the touchscreen's setting (i.e., whether the touchscreen is set to “active,” “standby,” or “sleep”). Based on the updated touch-processing state, the host processor may directly update the touchscreen settings in operation 386 as further described in FIGS. 5-6.

In another aspect, the host processor 306 may optionally send calibration parameters 388 to the transducer front end 302. These calibration parameters 388 may instruct the transducer to skew future touch signals similar to touch signal 376 in operation 390. This skewing may be required to teach the transducer how to remove noise that may systematically be incorporated into a touch signal generated from a touch input. For example, if the transducer receives signals from an electronic sensor connected to each row of the touchscreen panel, and readings from a particular row consistently and erroneously indicate that a touch input occurred (i.e., noise), the calibration parameters 388 may enable the transducer front end 302 to skew the signal from that particular row automatically to make it uniform with properly functioning rows. By skewing the signal from the problematic row, the transducer front end 302 may reduce noisy touch signals that are reported to the host processor 306, which may greatly increase processing efficiency.

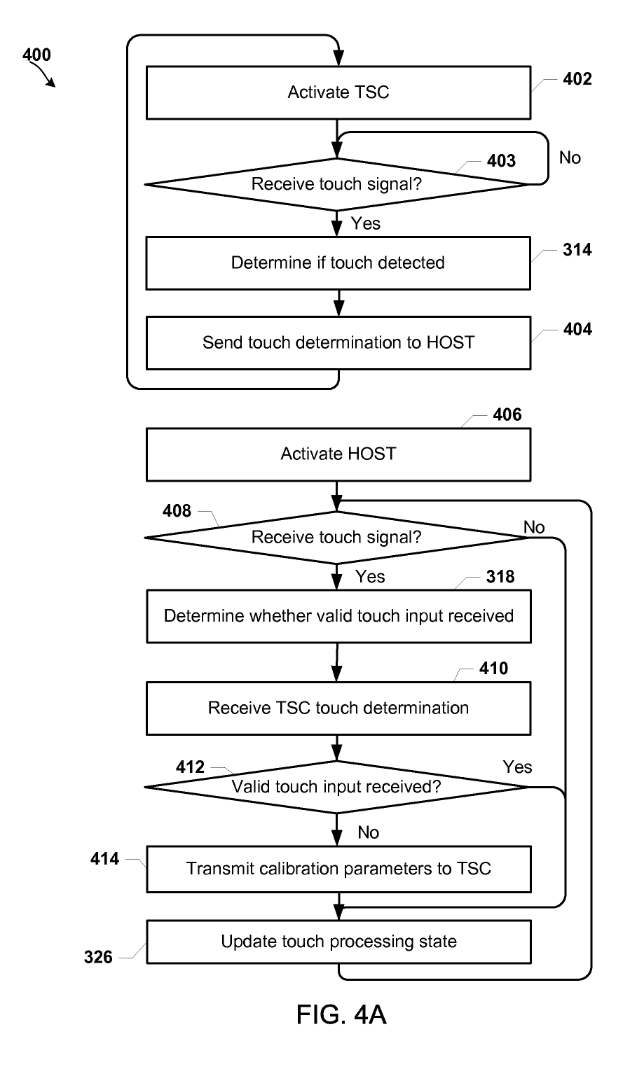

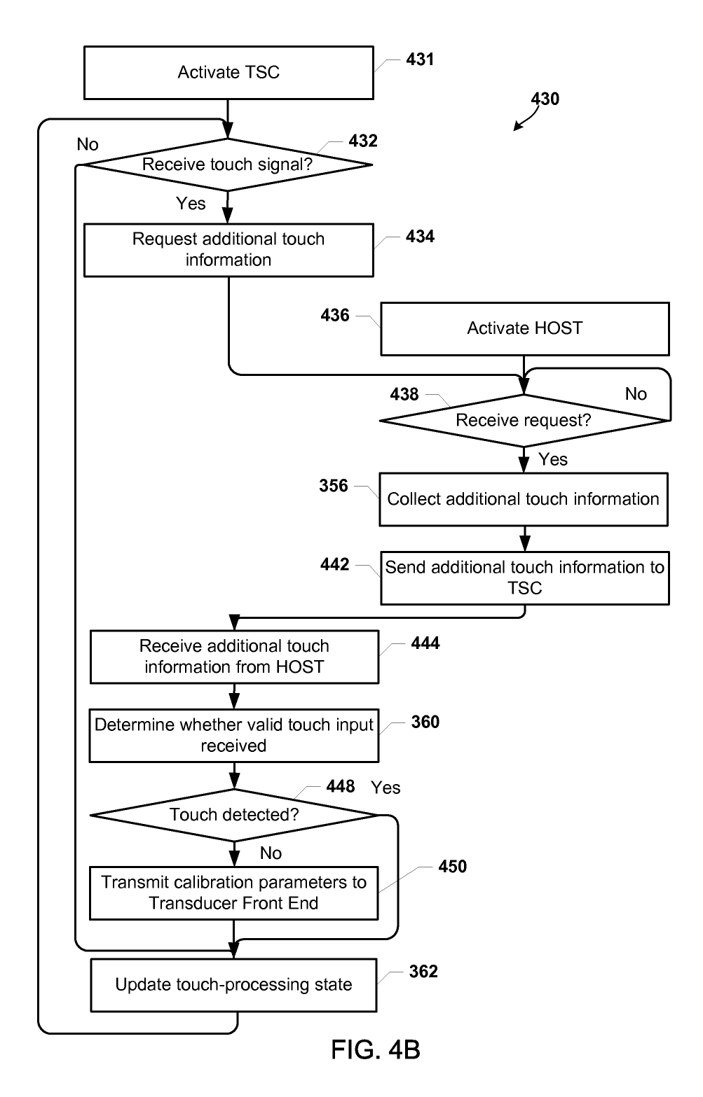

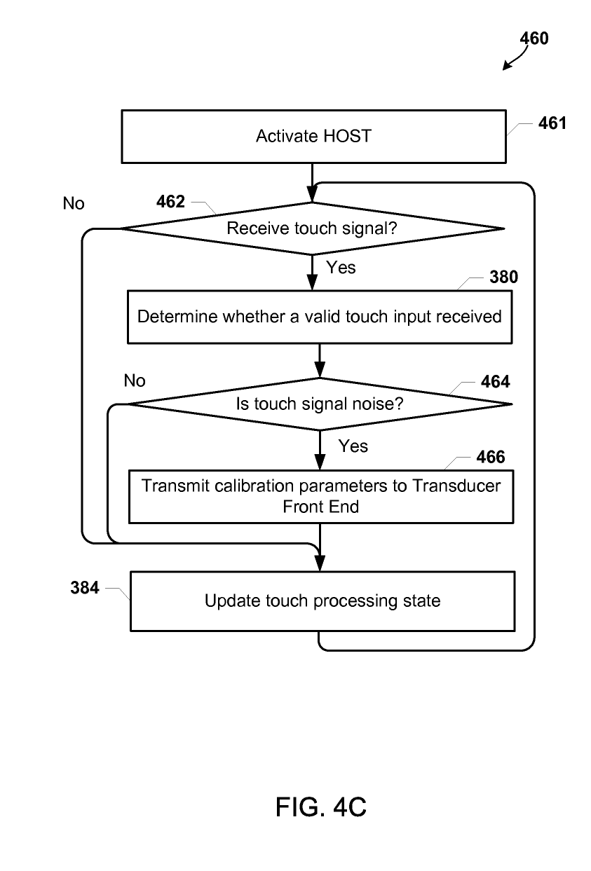

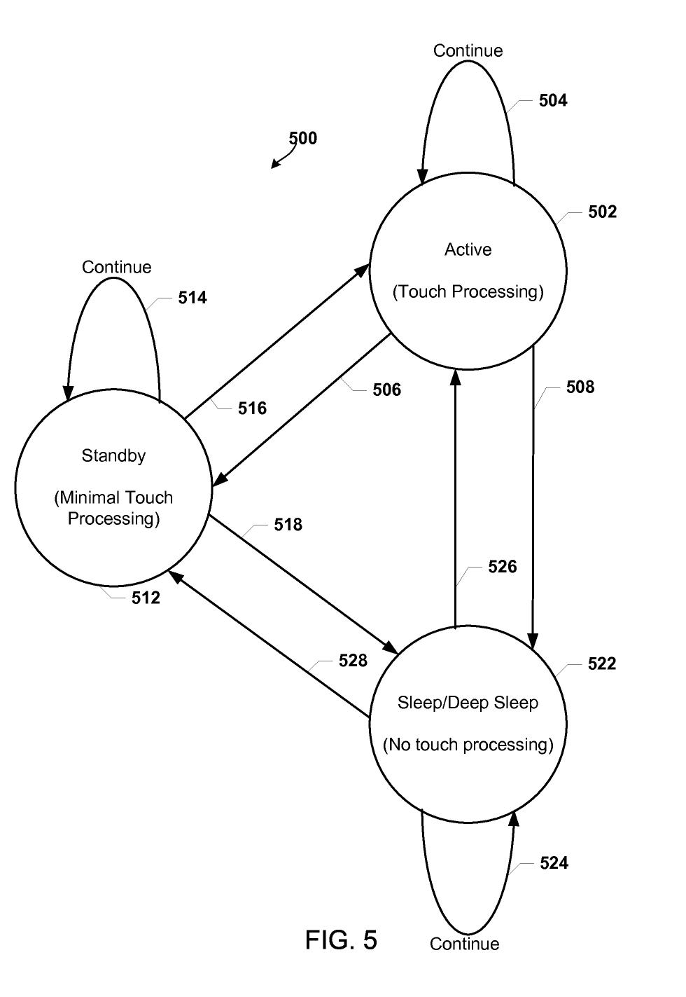

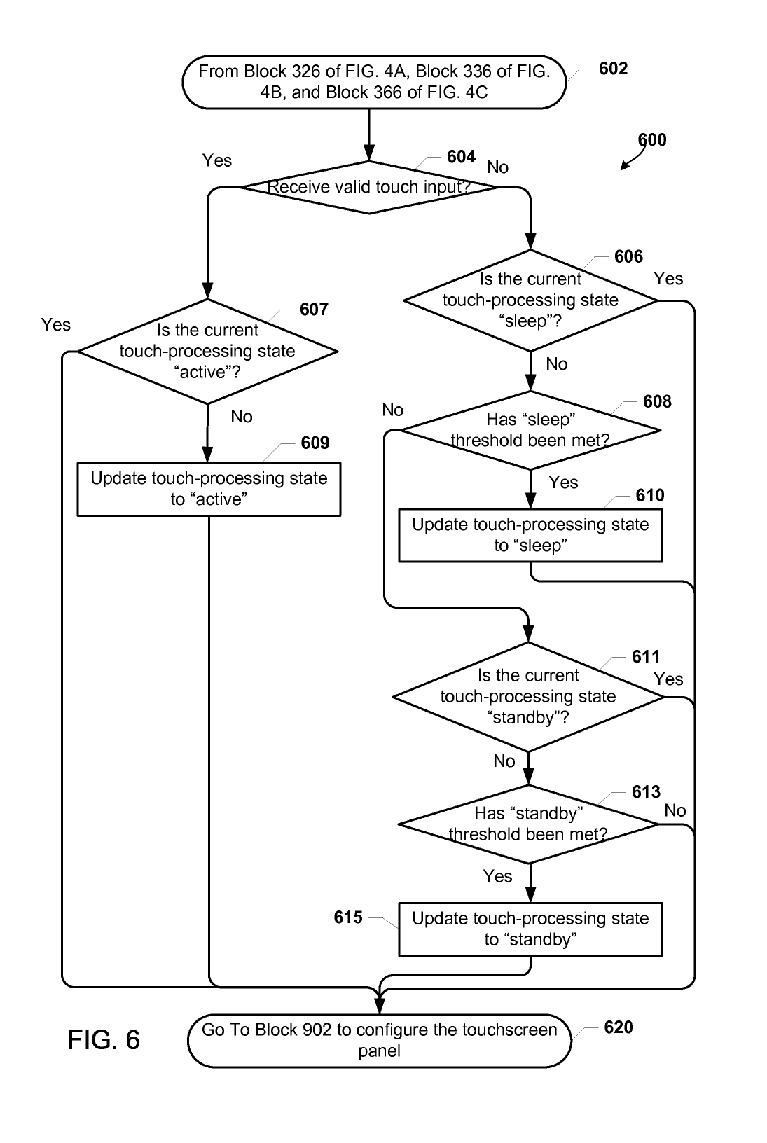

FIG. 4A illustrates an aspect touchscreen computing device method 400 for using a host processor to update a touch-processing state with additional input from a touchscreen controller. In block 402, the touchscreen controller may activate or be configured to response to detected touch inputs on the touchscreen panel. For example, the touchscreen computing device may utilize a data path that includes transmitting signals (e.g., touchscreen touch inputs) from a touchscreen panel to an analog front-end circuit, to a data binning component, to quantizer and integrator components, and finally to the touchscreen controller for further processing.

In determination block 403, the touchscreen controller may determine whether touch signal data has been received. In other words, the touchscreen controller may determine whether touchscreen touch inputs containing touch signal data are available for processing by the touchscreen controller. For example, the touchscreen controller may receive an interrupt signal indicating that touch inputs have been detected on the touchscreen panel. As another example, the touchscreen controller may receive an interrupt signal indicating that touchscreen touch inputs are available from an analog transducer front end. In an aspect, the touchscreen controller may periodically monitor for receipt of touchscreen touch inputs in a buffer (e.g., check for incoming signals once every millisecond). If no touch signal is received (i.e., determination 403=“No”), the touchscreen controller may continue operating in determination block 403.

If a touch signal is received (i.e., determination block 403=“Yes”), the touchscreen controller may determine in block 314 whether the received touch signal data represents a valid touch input rather than noise. As discussed above, noise may be information received by touch sensors at the touchscreen panel that does not represent valid user touch inputs. For example, noise may be errant or useless information reported by touch sensors. After determining whether the touch signal represents a valid touch input, the touchscreen controller may send its touch determination (i.e., the touchscreen controller's conclusion regarding the likelihood that the touch signal represents a valid touch input) to a host processor in block 404. The touchscreen controller may continue operating in determination block 403.

A host processor may activate in block 406. The host processor may receive an activation signal from, for example, the touchscreen controller. In determination block 408, the host processor may determine whether it has received a touch signal. For example, the host processor may receive an interrupt signal directly from the transducer front end indicating that touch inputs have been detected on the touchscreen panel. As another example, the touchscreen controller may send an interrupt signal indicating that touchscreen touch inputs are available from an analog front end circuit. In an aspect, the host processor may periodically monitor for receipt of touchscreen touch inputs in a buffer (e.g., check for incoming signals once every millisecond). If no touch signal is received (i.e., determination block 408=“No”), the host processor may update the touch-processing state in block 326 to reflect the fact that there is currently no touch input activity. The host processor may then continue operating in determination block 408.

If a touch signal is received (i.e., determination block 408=“Yes”), the host processor may determine in block 318 whether a touch occurred. In other words, the host processor may determine whether the received touch signal represents a valid touch input or noise. The host processor may rely on several indications to determine the likelihood that the touchscreen panel received a valid touch input. The host processor may process the touch signal by performing de-noising and signal enhancement and by applying gains to the signal to increase the signal-to-noise ratio. The host processor may also receiving information about what is rendered on the display at the touch signal's location. The host processor may additionally receive contextual information about how the user is using the touchscreen computing device from various sensors and applications operating on the touchscreen computing device. By performing these actions, the host controller may be able to better estimate the likelihood that the touchscreen panel received a valid touch input.

In block 410, the host processor may receive the touchscreen controller's touch determination (i.e., whether the touchscreen controller determined that the touch signal indicated a valid touch input). The host processor may use the touchscreen controller's determination to refine its own determination. For example, the touchscreen controller's determination may indicate that there is a low probability that the touchscreen panel received a valid touch input, while the host processor's determination may indicate that there is a high likelihood that the touchscreen panel received a valid touch input. In determination block 412, the host processor may use all available information to determine whether a valid touch input was received. If the there was not valid touch input received (i.e., determination block 412=“No”), the host processor may transmit calibration parameters to the touchscreen controller in block 414. These calibration parameters may be, for example, instructions or information that enables the touchscreen controller to recognize similar invalid touch inputs. In another example, the calibration parameters may allow the touchscreen controller to calibrate the transducer front end or to adjust the interrupt message generator that alerts the touchscreen controller and the host processor that a touch has been received. The host processor may update the touch-processing state in block 326 to reflect the fact that a valid touch input was not received on the touchscreen.

If the host processor did determine that the touchscreen panel received a valid touch input (i.e., decision block 412=“Yes”), the host processor may update the touch-processing state in block 326 to reflect that determination. For example, the host processor may set the touch-processing state to “active” because the touchscreen panel is currently receiving valid touch inputs. In any case, the host processor may continue to operate in determination block 408.

FIG. 4B illustrates an aspect touchscreen computing device method 430 for using a touchscreen controller to update a touch-processing state with additional input from a host processor. In block 431, the touchscreen controller may activate or be configured to response to detected touch inputs on the touchscreen panel. For example, the touchscreen computing device may utilize a data path that includes transmitting signals (e.g., touchscreen touch inputs) from a touchscreen panel to an analog front end circuit, to a data binning component, to quantizer and integrator components, and finally to the touchscreen controller for further processing.

In decision block 432, the touchscreen controller may determine whether a touch signal has been received. For example, the touchscreen controller may receive an interrupt signal indicating that touch inputs have been detected on the touchscreen panel. As another example, the touchscreen controller may receive an interrupt signal indicating that touchscreen touch inputs are available from an analog transducer front end. In an aspect, the touchscreen controller may periodically monitor for receipt of touchscreen touch inputs in a buffer (e.g., check for incoming signals once every millisecond). If no touch signal data is received (i.e., determination block 432=“No”), the touchscreen controller may update the touch-processing state in block 362 to reflect the fact that there is currently no touch input activity. The touchscreen controller may then continue operating in determination block 432.

If touch signal data is received (i.e., determination block 432=“Yes”), the touchscreen controller may request additional touch information from the host processor in block 434. The request may include the touch signal that the touchscreen controller received from the transducer front end. A host processor may activate in block 436. For example, the host processor may receive an interrupt signal from the touchscreen controller. In determination block 438, the host processor may check whether it has received a request. This request may originate from the touchscreen controller and may include the touch signal for which additional information is requested. If the host processor has not received a request (i.e., determination block 438=“No”), the host processor may continue operating in determination block 438. Otherwise (i.e., determination block 438=“Yes”), the host processor may collect additional touch information in block 356 regarding the touch signal that the touchscreen controller sent with the request. This additional touch information may relate to various types of information. For example, and as discussed above, the host processor may conduct preliminary processing of the touch signal to determine whether anything noteworthy (e.g., a button or other user interface mechanism rendered on the display) exists at the location on the display that corresponds to the touch coordinate that the touch signal indicated. In another example, the host processor may take readings or other measurements from various other sensors on the touchscreen computing device (e.g., accelerometers), that may provide a better understanding of the context surrounding the reported touch input. The host processor may also retrieve touch information from applications running on the touchscreen computing device that may further give context to the environment in which the putative touch occurred. For example, an application expecting one or more user touches around the time the touch allegedly occurred may make it more likely that a user actually did touch the touchscreen.

As part of the retrieval process, the host processor may compile this additional touch information to provide an overall estimate of the likelihood that the touchscreen panel received a valid touch input. In a less desirable aspect, the host processor may simply collect the additional touch information from the various sources without forming an estimate of the likelihood of there being a valid touch input.

In block 442, the host processor may send the additional touch information to the touchscreen controller. The touchscreen controller may receive the additional touch information from the host processor in block 444. The touchscreen controller may determine in block 360 whether a touch was detected. In making this determination, the touchscreen controller may process the touch signal and perform de-noising and other signal enhancements to see if the signal surpasses a noise threshold (i.e., a certain likelihood that the touch signal is not noise). The touchscreen controller may also incorporate the additional touch information from the host processor that may provide a better contextual understanding of the likelihood a valid touch input actually occurred by determining, for example, whether a touch input was expected by the applications running on the touchscreen computing device. The touchscreen controller may evaluate the touch signal and the additional information that the host processor provided to determine whether a touch actually occurred.

If the touchscreen controller does not determine that a valid touch input occurred (i.e., determination block 448=“No”), the touchscreen controller may transmit calibration parameters to the transducer front end. These calibration parameters may be instructions for the transducer front end to skew future touch signal readings from the touchscreen on one or more rows and/or one or more columns. For example, the transducer front end may repeatedly receive a reading on a particular row that indicates that a touch is occurring, but the touchscreen controller and the host processor may collaborate to determine that no touch is occurring. In the current aspect, the touchscreen controller may then transmit calibration parameters to the transducer front end in block 450. These calibration parameters may configure the transducer front end to skew problematic rows to be consistent with properly-functioning rows. The touchscreen controller may also update the touch-processing state in block 362 to reflect the fact that no valid touch input occurred. If the touchscreen controller did detect that a touchscreen panel received a valid touch input (i.e., determination block 448=“Yes”), the touchscreen controller may update the touch-processing state to reflect that the touchscreen panel is currently receiving valid touch inputs. The touchscreen controller may then continue operating in determination block 432.

FIG. 4C illustrates an aspect touchscreen computing device method 460 for using a host processor alone to update a touch-processing state. A host processor may be activated in block 461. For example, the host processor may directly receive a touch input signal from a transducer front end. In another example, the transducer front end may send an interrupt signal to the host processor before sending a touch signal. In this aspect, the host processor may receive touch signals directly from the transducer front end without participation by the touchscreen controller.

In determination block 462, the host processor may check whether it has received a touch signal. If the host processor does not receive a touch signal (i.e., decision 462=“No”), the host processor may update the touch-processing state in block 384. The host processor may change the touch-processing state to reflect that no touch input has been received, which may cause the touch-processing state to change. For example, if the current touch-processing state is “active” and the host processor has not detected a signal over a certain threshold period of time, the host processor may change the touch-processing state to “standby” to represent this period of inactivity.

Otherwise (i.e., decision 462=“Yes”), the host processor may determine whether the touchscreen panel received a valid touch input in block 380. As discussed in reference to FIGS. 4A-4B, the host processor may obtain contextual information about the reported touch input that may indicate a higher or lower likelihood that a valid touch input occurred. This contextual information may be gathered from various sources, such as the touchscreen computing device's display, other sensors, and the applications running on the touchscreen computing device.

If the host processor determined that the touch signal was noise (i.e., determination block 464=“Yes”), the host processor may transmit calibration parameters to the transducer front end in block 466. These calibration parameters may be instructions for the transducer front end to skew future touch signal readings from the touchscreen on one or more rows and/or one or more columns. For example, the transducer front end may repeatedly receive a reading from a particular row that indicates that a touch input occurred, but the host processor may determine that no valid touch input was ever received. In the current aspect, the host processor may then instruct the transducer front end to skew the readings from that row to make it consistent with the other properly-functioning rows. The touchscreen controller may also update the touch-processing state in block 384 to reflect the fact that no touch was detected. If the touchscreen controller did not determine that the touch signal was noise (i.e., determination block 464=“Yes”), the host processor may update the touch-processing state to indicate that a valid touch input was received. The host processor may then continue operating in determination block 462.

FIG. 5 illustrates an aspect state diagram 500 for maintaining a touch-processing state with three potential states. In an aspect, a touchscreen computing device may implement a state machine with three states and with rules for transitioning among a first state 502, a second state 512, and a third state 522. The three states may each correspond to a different touch-processing state (i.e., the current valid-touch-input activity received on a touchscreen panel). In an aspect, a first state 502 may be an “active” touch-processing state. An “active” state may indicate that the touchscreen has received at least one valid touch input within a given time threshold (e.g., within the last 20 seconds). A second state 512 may represent a “standby” state, which may indicate that a valid touch input has not been received within a certain time threshold. For example, if the touchscreen has not received a valid touch input for at least 20 seconds, the touch-processing state may be set to “standby.” A third state 522 may be a “sleep” state. A “sleep” state may occur when a touchscreen has not received a valid touch input within a second time threshold (i.e., a threshold time period longer than the “standby” threshold). For example, if the touchscreen computing device has not received a touch for 10 minutes, the touch-processing state may be set to “sleep.”

A first state 502 may have various rules for transitioning. If the touch-processing state is in a first state 502 (i.e., “active”) and the touchscreen panel is currently receiving or has received valid touch inputs within a first threshold time period (i.e., the “standby” threshold), the touch-processing state may continue to remain “active” through transition 504. If the touchscreen has not received a touch within a certain threshold, an “active” touch-processing state may transition to a second state (i.e. “standby”) through transition 506 to reflect the touchscreen panel's recent inactivity. A touch-processing state in the first state 502 may transition to a third state 522 (i.e. “sleep”) if, for example, the user manually triggers a transition 508 by turning off the touchscreen computing device or by selecting an option to deactivate the touchscreen panel. This may occur when a user has finished using the touchscreen computing device and wishes to put the touchscreen computing device to sleep to conserve battery power or when a user decides to lock the touch screen to prevent all touch inputs (e.g., when putting the touchscreen computing device in the user's pocket).

A second state 512 may have various rules for transitioning. If a touch-processing state is in a second state 512 (i.e., “standby”) and the touchscreen panel continues not to receive valid touch input within a second threshold time period (i.e., the “sleep” threshold), the touch-processing state may continue to remain at “standby” through transition 514. If the touchscreen panel has not received a valid touch input within a second threshold time period, a touch-processing state in the second state 512 may transition to a third state 522 (i.e. “sleep”) through transition 518 to reflect the touchscreen's relative inactivity. A touch-processing state in the second state 512 may transition to a first state 502 (i.e. “active”) if, for example, the user manually triggers a transition 516 by touching the touchscreen. This may occur when a user has resumed using the touchscreen computing device.

A third state 522 may have various rules for transitioning. If a touch-processing state is in a third state 522 (i.e., “sleep”) and the touchscreen panel continues not to receive valid touch inputs, the touch-processing state may continue to remain at “sleep” through transition 524. A touch-processing state in a third state 522 may transition to a first state through transition 526, for example, by having a user activate an “on” button or switch or by receiving a valid touch input on the touchscreen panel. It may also be possible for a touch-processing state to transition from a third state 522 to a second state 512 through similar means. For example, a user may intend to use the touchscreen computing device relatively soon and desires the touchscreen to be ready to receive touch input at some point in the near future but not immediately. A touch-processing state in the second state 512 may transition to a first state 502 (i.e. “active”) if, for example, the user manually triggers a transition 516 by, for example, pushing an “on” button on the touchscreen computing device. This may occur when a user wishes to wake up the touchscreen computing device to receive immediate touch inputs.

FIG. 6 illustrates an aspect touchscreen computing device method 600 for changing a touch-processing state based on whether a valid touch input is received. A host processor may transition to transition block 602 from block 326 of FIG. 4A, block 336 of FIG. 4B, or block 366 of FIG. 4C. If the transition to transition block 602 is from block 336, then a touchscreen controller, in another aspect, may perform the actions of method 600. For the purpose of describing the remainder of an aspect of method 600, it may be assumed, without limitation, that a host processor is performing the actions. However, it would be obvious to an ordinary person skilled in the art that method 600 may be performed by other processors, including a touchscreen controller.

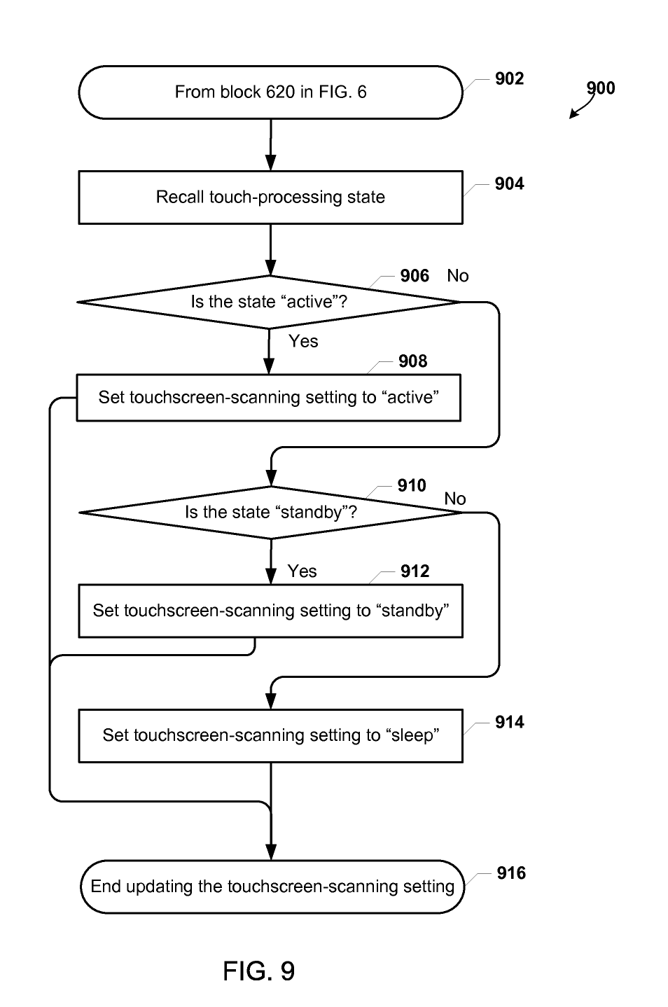

In determination block 604, a host processor may recall whether the touchscreen panel received a valid touch input. If a touch actually occurred (i.e., determination block 604=“Yes”), then the host processor may determine whether the touch-processing state is currently set to “active.” If the touch-processing state is not currently set to “active” (i.e., determination block 607=“No”), the host processor may update the touch-processing state to “active” in block 609. This update may reflect the fact that the touch-processing state had been in another state (i.e., “standby” or “sleep”) due to inactivity. At transition block 620, the host processor may begin to implement the current touch-processing state on the touchscreen panel in block 902 as described below with reference to FIG. 9. If the touch-processing state was already set to “active” (i.e., determination block 607=“Yes”), the host processor may transition from block 620 to block 902 to begin implementing the current touch-processing state on the touchscreen panel.

If the touchscreen did not receive a valid touch input (i.e., determination block 604=“No”), the host processor may determine in determination block 606 whether the current touch-processing state is “sleep.” A “sleep” state may correspond to a prolonged period of inactivity as discussed above with reference to FIG. 5. If the current touch-processing state is “sleep” (i.e., determination block 606=“Yes”), the host processor may transition from block 620 to block 902 to begin implementing the current touch-processing state on the touchscreen panel. Otherwise (i.e., determination block 606=“No”), the host processor may determinate in determination block 608 whether the period of inactivity has exceed a “sleep” threshold. A “sleep” threshold, as explained in context of FIG. 5, may be a period of time that exceeds a certain threshold period of inactivity. For example, if the current touch-processing state is “standby” and the host processor has detected that touch input inactivity has continued for an extended period of time, the host processor may decide that the touch-processing state should be changed to “sleep” to save battery power.

If the host processor determines that the “sleep” threshold has been met (i.e., determination block 608=“Yes”), the host processor may update the touch-processing state to “sleep” in block 610. This change of state may reflect the fact that the touchscreen computing device has not been used or received a valid touch input for an extended period of time. The host processor may also transition from block 620 to block 902 to begin implementing the current touch-processing state on the touchscreen panel.

If the host processor determines that the “sleep” threshold has not been met (i.e., determination block 608=“No”), the host processor may determine in determination block 611 whether the current touch-processing state is “standby.” If the current touch-processing state is “standby” (i.e., determination block 611=“Yes”), the host processor may transition from block 620 to block 902 to begin implementing the current touch-processing state on the touchscreen panel. Otherwise (i.e., determination block 611=“No”), the host processor may determine whether a “standby” threshold has been met in determination block 613. A “standby” threshold may reflect a period of inactivity that is not prolonged, or, in other words, is less than the “sleep” threshold. For example, a “standby” threshold may be reached after 30 seconds of inactivity, and a “sleep” threshold may be reached after 10 minutes of inactivity. In a further example, after receiving a touch, the touch-processing state may be “active” for 30 seconds then may transition to “standby.” If no valid touch input is received for 10 minutes, the touch-processing state may transition from “standby” to “sleep.”

If the host processor determine in determination block 613 that the “standby” threshold has not been met (i.e., determination block 613=“No”), the host processor may transition from block 620 to block 902 to begin implementing the current touch-processing state on the touchscreen panel. Otherwise (i.e., determination block 613=“Yes”), the host processor may update the touch-processing state to “standby” in block 615. This situation may occur when the touch-processing state was “active,” but the period of time the touchscreen has been inactive has surpassed the “standby” threshold. The host processor may transition from block 620 to block 902 to begin implementing the current touch-processing state on the touchscreen panel.

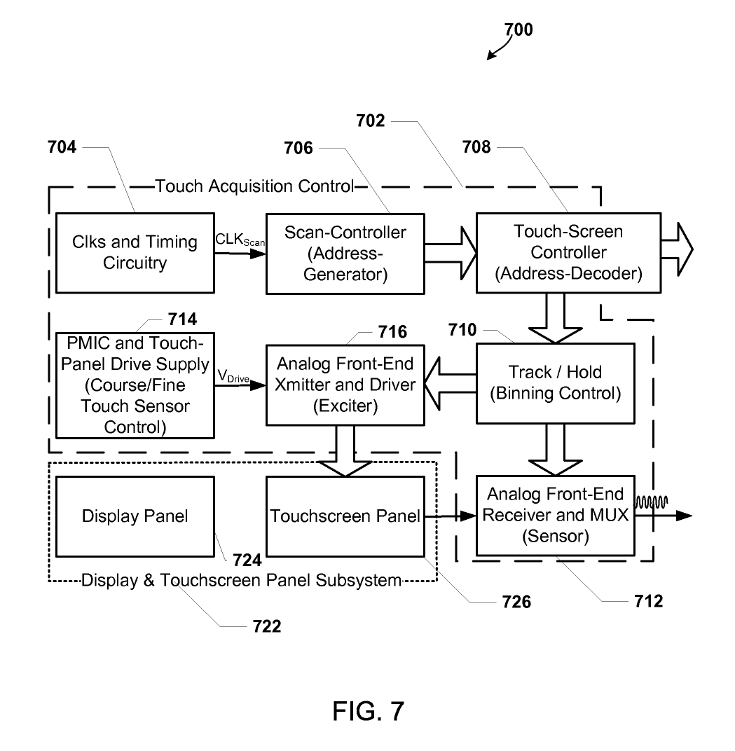

FIG. 7 illustrates an adaptive touch acquisition and panel system 700 containing various specialized circuitries suitable for use with the various aspects. A touch acquisition control subsystem 702 may be configured to operate and receive data from a touchscreen panel 726. Along with a display panel 724, a touchscreen panel 726 may be a part of a display and touchscreen panel subsystem 722 that is configured to receive valid touch inputs on the touchscreen panel and to display rendered graphics to the user on the display panel 724 partially in response to valid touch inputs.

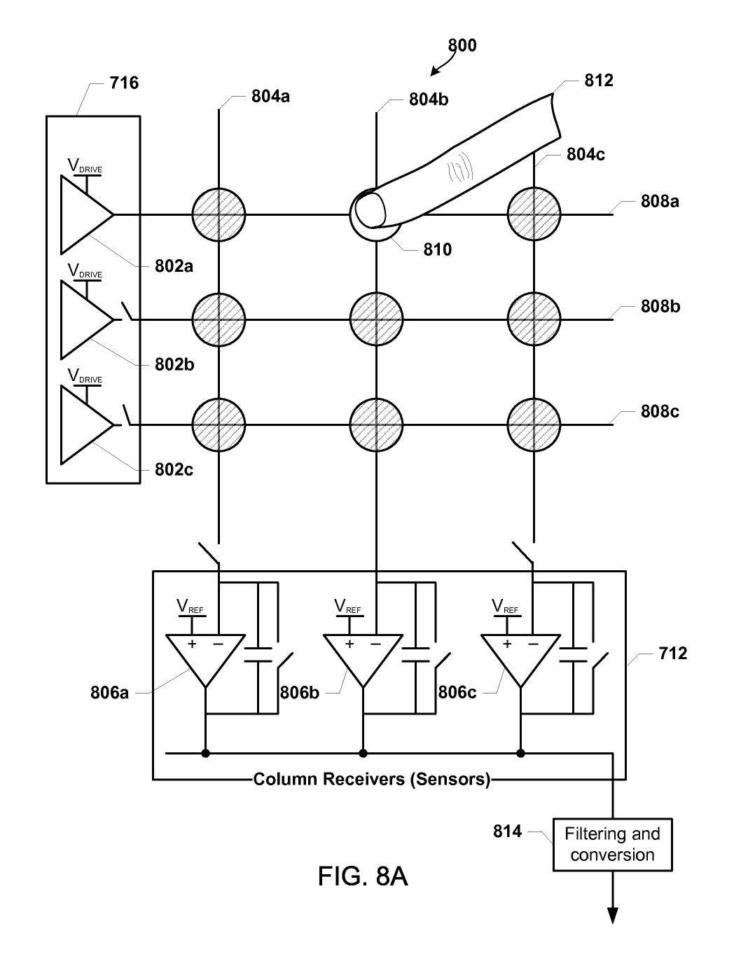

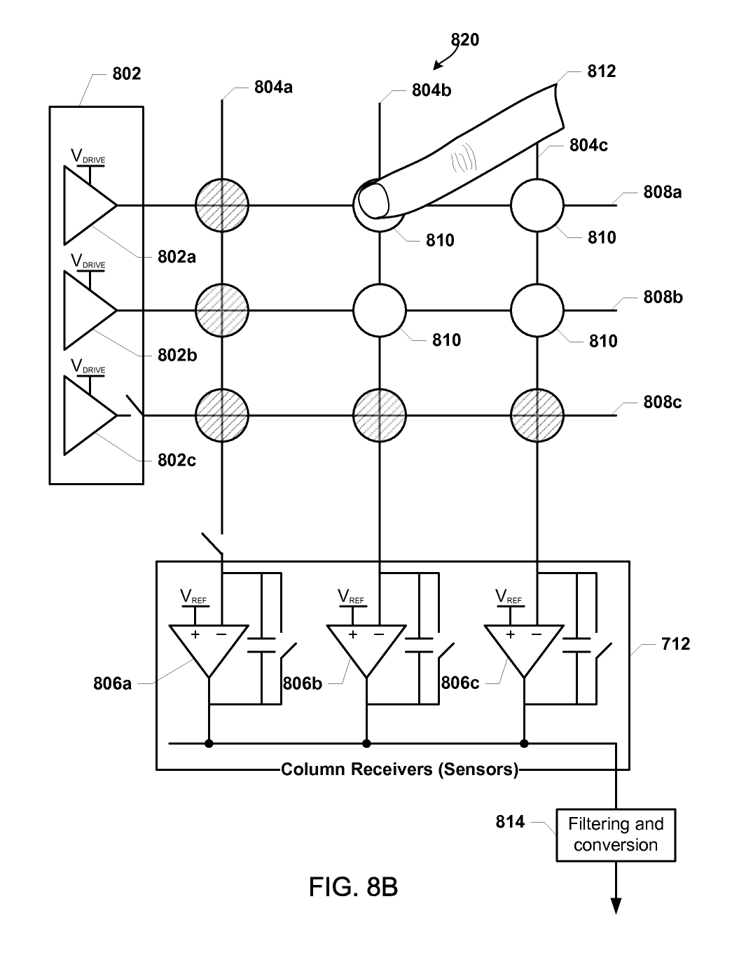

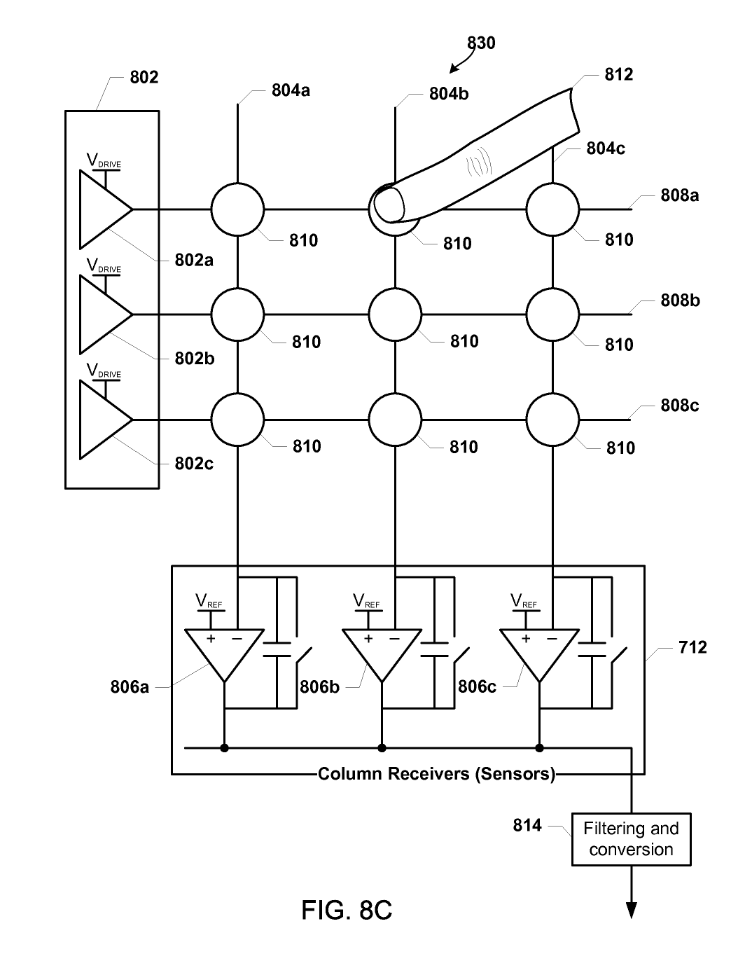

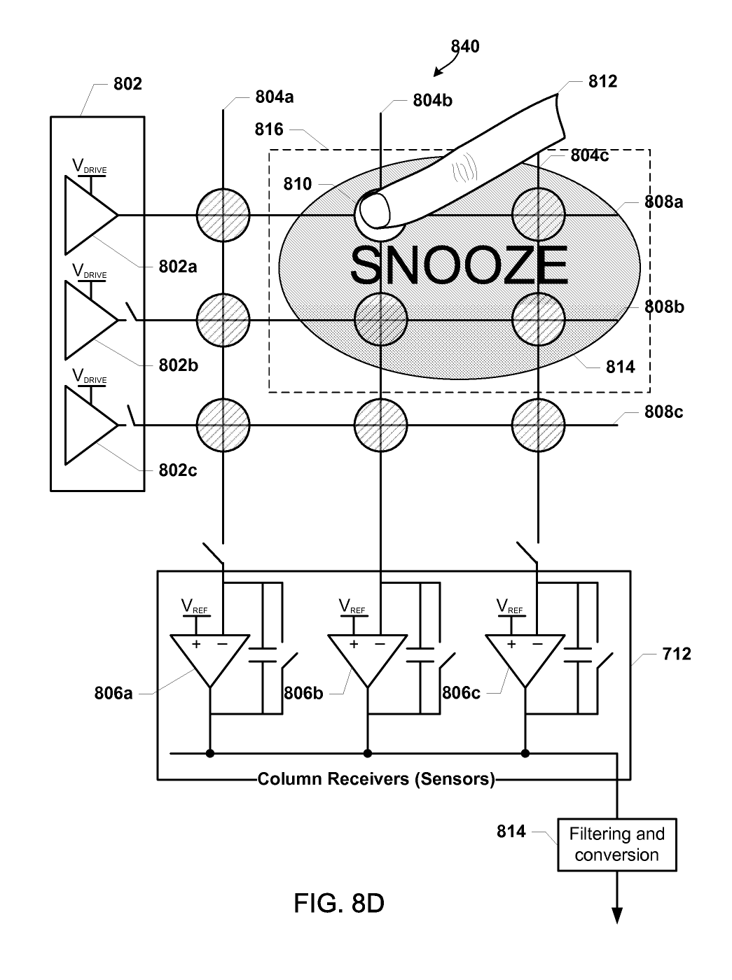

The touch acquisition control subsystem 702 may contain a clock and timing circuitry 704 configured to manage the rate in which the touchscreen panel 726 is scanned. The clock and timing circuitry 704 may send a particular scanning rate timing scheme (i.e., CLK_{Scan}) to a scan controller 706. The scan controller 706 may be configured to manage the conditions for scanning the touchscreen panel 726. The scan controller 706 may also be in communication with a touchscreen controller 708 that may generally manage the touch acquisition process. The touchscreen controller 708 may be configured to output instructions to a track and hold module 710. The track and holding module may primarily conduct binning control (i.e., remembering previous touch events for correlation with a current touch input). The track and hold module 710 may be configured to communicate with an analog front end transmitter 716 and an analog front-end receiver 712. The analog front-end transmitter 716 may correspond to rows on a touch panel that drive an electric signal through the rows and columns of the touchscreen panel 726. The analog front-end transmitter 716 may receive, for example, a voltage drive from a power management integrated circuit and touchscreen drive supply module 714. The power management integrated circuit and touchscreen drive supply module 714 may be configured to adjust the amount of voltage driven through the analog front-end transmitter 716 depending on whether a course or fine touchscreen resolution is desired (i.e., whether the rows and columns are aggregated as described in FIGS. 8A-8D). The signal driven through the touchscreen panel 726 may be received by an analog front-end receiver 712, which may be configured to sense the signal driven from the analog front-end transmitter 716 through the touchscreen panel 726. The analog front-end receiver 712 may be configured to output an analog signal based on the signal received from the touchscreen panel 726.

FIGS. 8A-8D each illustrate a portion of an aspect projected capacitance touchscreen panel according to varying touchscreen-scanning settings. In an aspect, a portion of a touchscreen panel may include an analog front-end transmitter 716 with row drivers 802a-802c, an analog front-end receiver 712 (i.e., a multiplexor) with column sensors 806a-806c, conductive columns 804a-804c, and conductive rows 808a-808c. As described above with reference to FIG. 7, an analog front-end transmitter 716 may be configured to send an electric signal (e.g., voltage) from individual row drivers 802a-802c through their respective rows 808a-808c. Each of the row drivers 802a-802c may be connected to a single row by a switch. Any number of row drivers 802a-802c may be switched to their respective rows 808a-808c and capable of driving a signal through those rows 808a-808c at any particular time. The rows 808a-808c may be in contact with and able to pass an electric signal to a plurality of columns 804a-804c. In a particular aspect, the rows 808a-808c and columns 804a-804c may be placed on a touchscreen panel in a perpendicular grid pattern. The columns 804a-804c may be configured to connect to column sensors 806a-806c through switches. Thus, any number of columns 804a-804c may be connected to column sensors 806a-806c. For example, column 804b may be switched to connect to column sensor 806b, but the other columns may not be switched to connect to their respective column sensors at that time. A column sensor switched to its column may receive an electric signal that originates at a row driver, passes through a row, and then passes through the column sensor's column.

The column sensors 806a-806c may receive the electric signal from the columns 804a-804c and compare that electric signal with a reference signal. For example, a row driver 802a may drive a voltage through row 808a, which may pass through column 804b into column sensor 806b. Column sensor 806b may check the received signal's voltage against a reference voltage value (i.e., V_{REF}). Column sensors 806a-806c may be configured to send an analog signal for filtering and conversion in block 814 when the received signal does not meet a certain threshold based on the reference signal. In the above example, column sensor 806b may send an analog signal indicating whether the received voltage met a threshold based on a reference voltage, V_{REF}.

The touchscreen computing device may scan for a touch input 812 on the touchscreen panel by measuring the output of a signal driven through one or more rows and columns and received by one or more a column sensor. For example, a row is “scanned” by driving an electric signal from a row driver through the row, passing the electric signal from the row to one or more columns, and receiving the electric signal on one or more column sensors. A scanned coordinate 810 may be the area on the touchscreen panel in which a touch input may be detected. A scanned coordinate 810 may correspond to a row-column intersection of a row switched to a row driver and a column switched to a column sensor. A column sensor may be configured to detect a touch input 812 at a scanned coordinate 810 when a touch input 812 affects the electrical properties at the scanned coordinate 810.

If the touchscreen panel has fewer row drivers and/or column sensors switched “on” at one time, the touchscreen panel may have a high detection resolution (i.e., a finer detection granularity). For example, scanning by one row and one column at a time may provide a high detection resolution because a very small areas is being scanned. If the touchscreen panel has more row drivers and/or column sensors switched “on” at the same time, the touchscreen panel may have a lower detection resolution (i.e., a coarser detection granularity). For example, scanning multiple rows and/or columns at the same time may reduce touch input detection precision because a larger area is being scanned at the same time. In an aspect, a high resolution may mean that a touchscreen panel may detect the exact location of a touch input. A middle resolution may mean that a touchscreen computing device may detect the general area in which a touch occurred. A low resolution may mean that a touchscreen computing device may detect only that a touch occurred and not the location of the touch.

In various aspects, the precision of touch detection on a touchscreen panel (i.e., the scan resolution) may be set based on the current touch-processing state. In the various aspects, the drive strength from the row drivers may be adapted to accommodate a particular scan resolution. In a further aspect, a scan of a touchscreen panel may be restricted to a particular area of the touchscreen panel (i.e., a certain grouping of rows and columns).

FIG. 8A illustrates a portion of an aspect conductive touchscreen panel system 800 according to an “active” touchscreen-scanning setting. In an aspect, a touchscreen-scanning setting may be set to “active,” which may configure the touchscreen panel to use a high scan resolution to determine the location of a touch with high precision. For example, a touchscreen computing device may require a high scan resolution to accommodate a user who is using a soft QWERTY keyboard. A high scan resolution may thereby ensure that the touchscreen computing device can distinguish between which keys the user touched.

A touchscreen-scanning setting of “active” may therefore require that one row and one column be scanned at a time. For example, row driver 802a may be switched to row 808a, and column sensor 806b may be switched to column 804b. No other row drivers or column sensors may be switched to rows and columns, respectively. The row driver 802a may drive an electric signal to column sensor 806b through row 808a and column 804b. If a touch input 812 occurs at scanned coordinate 810, column sensor 806b may be configured to detect the change in electric properties caused by the touch input 812 at that location. Because only one driver and one receiver are active at a time, the location of a touch input 812 (i.e., the scanned coordinate 810) may be determined with high precision.

FIG. 8B illustrates a portion of an aspect conductive touchscreen panel system 820 according to a “semi-active” touchscreen-scanning setting. In an aspect, a touchscreen panel in a “semi-active” touchscreen state may require a mid-range scan resolution to determine the location of a touch with rough precision.

A touchscreen-scanning setting set to “semi-active” may configure the touchscreen panel to scan a plurality of rows and/or columns at the same time, thereby scanning a larger area than an “active” touchscreen-scanning setting. For example, row driver 802a and row driver 802b may be switched to row 808a and to row 808b, respectively. Column sensor 806b and column sensor 806c may be switched to column 804b and column 804c, respectively. In an example, the row driver 802a and row driver 802b may drive electric signals to column sensor 806b and column sensor 808c through rows 808a and 808b and columns 804b and 804c. If a touch input 812 occurs at the intersection of row 808a and column 804b, column sensor 806b may be configured to detect the change in electric properties caused by the touch input 812 because the touch input occurred at a scanned coordinate 810. A touch input 812 may also be detected at the intersections of row 808a and column 804c, row 808b and column 804b, and row 808b and column 804b (i.e., the remaining scanned coordinates 810). Because a plurality of row drivers and column sensors may be active at the same time, the location of a touch input 812 may not be determined with high precision because a larger areas is being scanned. In other words, the touchscreen panel may only detect that a touch input 812 occurred at one of the scanned coordinates 810, not the specific scanned coordinate 810.

FIG. 8C illustrates a portion of an aspect conductive touchscreen panel system 830 according to a “standby” touchscreen-scanning setting. A touchscreen-scanning setting in “standby” may configure the touchscreen panel to have a low detection resolution because the location of the touch is unimportant. For example, a touchscreen computing device may require a low resolution to detect that a user is touching the touchscreen in order to make the touchscreen panel “active.” In this example, while the touchscreen panel is in a “standby” state, the touchscreen panel may not expect to receive a touch, and the touchscreen panel may only need to know that it is being touched to transition to an “active” state (i.e., a high scanning resolution). Thus, a touchscreen panel in a “standby” state may not require scanning one row and one column at a time. Instead, the touchscreen panel may adjust the drive strength of the electric signal to scan every row and every column simultaneously (i.e., the entire touchscreen) and wait for a user to touch anywhere on the screen. By driving on every row and simultaneously sensing on every column, the touchscreen panel may be able to determine that a touch input 812 occurred, but nothing about the location of the touch input 812.

While not displayed, a touchscreen-scanning setting of “sleep” may disable the touchscreen. This may occur when a user desires to lock the touchscreen while the touchscreen computing device is, for example, being carried in the user's pocket and the user wants to avoid unintentional touch inputs.

FIG. 8D illustrates a portion of an aspect conductive touchscreen panel system 840 according to a multiple touchscreen-scanning setting. In an aspect, a touchscreen panel may apply a different scanning setting in a touchscreen area 816. The touchscreen area 816 may correspond with a graphic or button with which the user may interact. In an aspect, the touchscreen-scanning setting for a touchscreen area 816 may be “active,” “standby,” and “sleep” as described above. For example, a host processor may set the touchscreen-scanning setting in touchscreen area 816 to “active” while other areas of the touchscreen panel may be set to “standby.” Setting different areas of the touchscreen panel to different touchscreen-scanning rates may be appropriate when it is important to determine the exact location of a touch input on one region of the touchscreen panel and it is not important to determine the location of a touch input in another area.

FIG. 9 illustrates an aspect touchscreen computing device method 900 for using a touch-processing state to update the touchscreen-scanning setting. In an aspect, a host processor may perform method 900. However, anyone of ordinary skill in the art would appreciate that another processor (e.g., a touchscreen controller) may perform the actions of method 900. Also, while aspect method 900 is described in reference to an entire touchscreen panel, the host processor may perform aspect method 900 to affect one or more portions of the touchscreen panel (i.e., touchscreen areas 816) as discussed above with reference to FIG. 8D.

In an aspect, a host processor may transition to block 902 from block 620 in FIG. 6. In block 904, the host processor may recall the touch-processing state. The touch-processing state may have been set to one of “active,” “standby,” and “sleep.” In determination block 906, the host processor may determine whether the touch-processing state is “active.” If the touch-processing state is “active” (i.e., determination block 906=“Yes”), the host processor may set the touchscreen-scanning setting to “active.” As discussed with regards to FIG. 8A, an “active” scan rate may configure the touchscreen panel to scan one row and one column at a time to ensure a high scan resolution. An “active” scan rate may be necessary when it is necessary or desirable to know the exact location of a user's touch (e.g., when using soft QWERTY keyboards or when playing a game). After updating the scan rate status to “active,” the host processor may end updating the touchscreen-scanning setting in block 916.

If the touch-processing state is not “active” (i.e., determination block 906=“No”), the host processor may determine whether the touch-processing state is set to “standby” in determination block 910. If the touch-processing state is “standby” (i.e., determination block 910=“Yes”), the host processor may set the touchscreen-scanning setting to “standby.” As discussed with regards to FIG. 8C, a “standby” touchscreen-scanning setting may configure the touchscreen panel to scan every row and every column simultaneously (i.e., scan at a low resolution). A “standby” scan rate may be desired when the location of a user's touch is not important and when a user's touch is not immediately anticipated (e.g., when watching a movie or after a period of inactivity). After updating the scan rate status to “update,” the host processor may end updating the touchscreen-scanning setting in block 916.

If the touch-processing state is not “standby” (i.e., determination block 910=“No”), the host processor may set the touchscreen-scanning setting to “sleep,” which may configure the touchscreen panel not to scan any row or column (i.e., to turn the touchscreen panel off). A “sleep” touchscreen-scanning setting may be desired when a user's touch input is not anticipated for an extended period of time or no activity has been detected on the touchscreen panel for a prolonged period of time. After updating the scan rate status to “sleep,” the host processor may end updating the touchscreen-scanning setting in block 916.

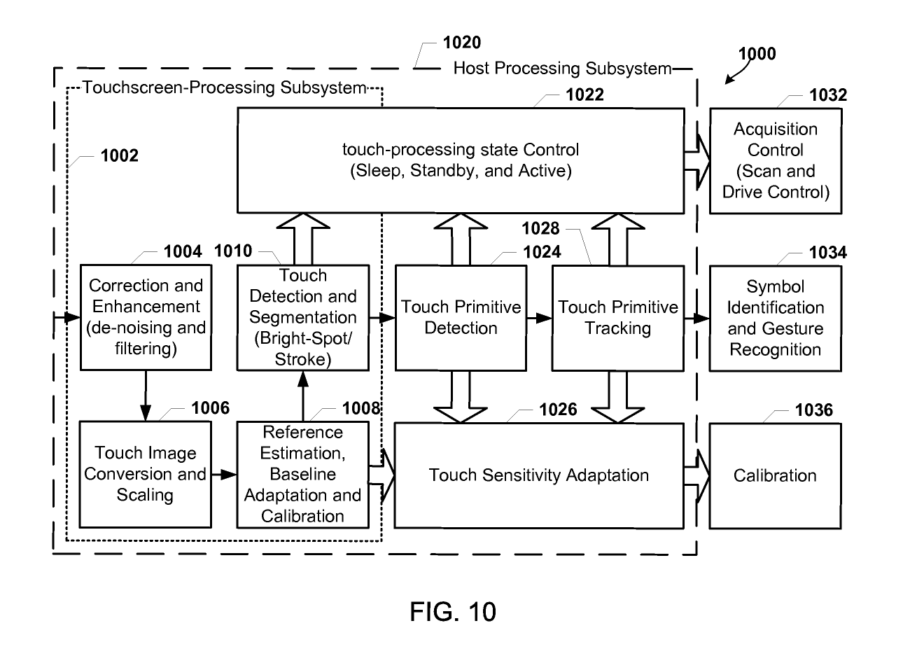

FIG. 10 illustrates a touch signal data path system 1000 suitable for use with the various aspects. In an aspect, a host processor may perform the functions included in both the touchscreen-processing subsystem 1002 and the host processing subsystem 1020. Touchscreen-processing subsystem 1002 includes various modules configured to receive and process a touch signal to determine whether a touchscreen panel received a valid touch input. A host processing subsystem 1020 may primarily be responsible for transforming a touch signal into a form other applications or components of a touchscreen computing device may use.

A correction and enhancement module 1004 may receive the digital touch signal from a transducer front end and perform de-noising and other signal filtering. By noising and enhancing the touch signal, the correction and enhancement module 1004 may increase the signal-to-noise ratio. The correction and enhancement module 1004 may send the touch signal to a touch image conversion and scaling module 1006, which may convert and scale the touch signal image. The touch image conversion and scaling module 1006 may send the touch signal to a reference estimation, baseline adaptation, and calibration module 1008, which may perform various calibrations on the touch signal. The reference estimation, baseline adaptation, and calibration module 1008 may be in communication with a touch sensitivity adaptation module 1026, which may adjust the sensitivity of the touchscreen panel in response to a determination that the touchscreen panel is either overly- or underly-sensitive. The reference estimation, baseline adaption, and calibration module 1008 may send the touch signal to a touch detection and segmentation module 1010. The touch detection and segmentation module 1010 may detect whether a valid touch input was received and further extract the touch signal data corresponding to the valid touch input from touch signal data related to noise. The touch detection and segmentation module may be in communication with a touch signal processing state control module 1022, which may update the touch-processing state of the touchscreen computing device (i.e., “active,” “standby,” and “sleep”) based in part on whether a valid touch input was detected at the touch detection and segmentation module 1010.

If a valid touch input is detected, the touch detection and segmentation module 1010 may send the touch signal to a touch primitive detection module 1024, where the touch signal is decoded to determine the touch primitive captured by the touchscreen panel. The touch primitive detection module 1024 may be in communication with both the touch signal processing state control module 1022 and the touch sensitivity adaptation and may provide input to these modules. The touch primitive detection module 1024 may send the touch signal to a touch primitive tracking module 1028, which may further decode the touch signal to compare the touch input location indicated by the touch signal with previous touch input locations. For example, the touch primitive tracking module 1028 may track the path of a finger as it slides across a touchscreen panel. The touch primitive tracking module 1028 may be in communication with the touch signal processing state control module 1022 and the touch sensitivity adaptation module 1026 and may provide inputs to these modules. The touch signal processing state control module 1022 may be in communication with an acquisition control module 1032, which may control the touchscreen panel's scanning and signal driving. The touch sensitivity adaptation module 1026 may be in communication with a calibration module 1036, which may calibrate and adjust the transducer front end to enable the transducer front end to generate signals with less noise and/or in a more useable form. The touch primitive tracking module 1028 may send the touch signal to a symbol identification and gesture recognition module 1034. The symbol identification and gesture recognition module 1034 may further decode the touch signal to determine gestures such as a drag, a flick, or a pinch. These determinations may be sent to applications or other components operating on the touchscreen computing device for further processing.

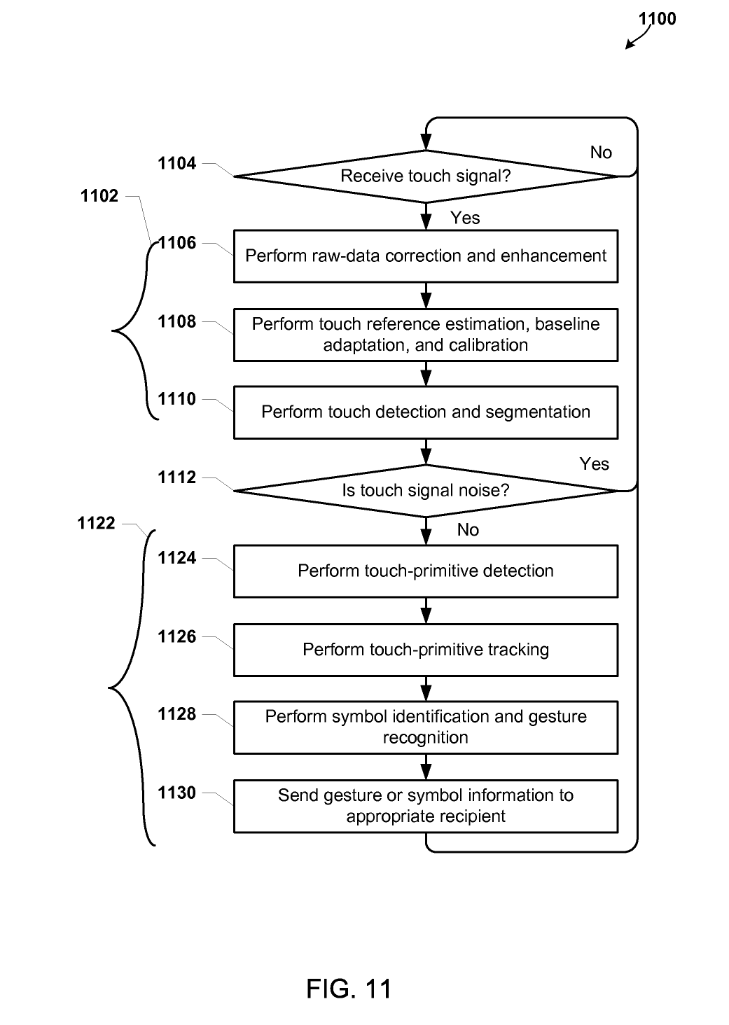

FIG. 11 illustrates an aspect host processor method 1100 for processing a touch signal. In determination block 1104, a host processor may determine whether it has received a touch signal. The touch signal may be sent by, for example, a touchscreen controller or directly from a transducer front end. If the host processor has not received a touch signal (i.e., determination block 1104=“No”), the host signal may continue operating in determination block 1104. Otherwise (i.e., determination block 1104=“Yes”), the host processor may perform raw data correction and enhancement in block 1106. Raw data correction and enhancement may include de-noising a touch signal and performing other filtering and signal enhancement. For example, the host processor may apply gains to the touch signal to enhance the signal-to-noise ratio. In block 1108, the host processor may perform touch reference estimation, baseline adaptation, and calibration of the touch signal. The host processor may also perform touch detection and segmentation in block 1110. Blocks 1106, 1108, and 1110 may be part of a touchscreen-processing subsystem 1102. In other words, blocks 1106, 1108, and 1110 may be actions the host processor undertakes to determine whether the touchscreen panel received a valid touch input and includes many techniques to discriminate a valid touch signal from noise.

In determination block 1112, the host processor may determine whether a touch signal is noise. The host processor may determine whether the signal is noise or represents an actual touch to decide whether additional processing is necessary. If the touch signal is noise (i.e., determination block 1112=“Yes”), the host processor may continue operating in determination block 1104, where it may wait until it receives another touch signal. Otherwise (determination 1112=“No”), the host processor may perform touch-primitive detection in block 1124. The host processor may also perform touch-primitive tracking in block 1126. In block 1128, the host processor may perform symbol identification and gesture recognition. In block 1130, the host processor may send gesture or symbol information to the appropriate recipient. Recipients may be, for example, applications currently running on the touchscreen computing device that may receive the processed touch signal as the user's input or selection.

The group of block 1122 (i.e., block 1124, 1126, 1128, and 1130) may represent traditional processing functions of a host processor, in which the host processor receives a signal of an actual touch and converts it into a usable form, such as user input. After performing in block 1130, the host processor may continue operating in determination block 1104.

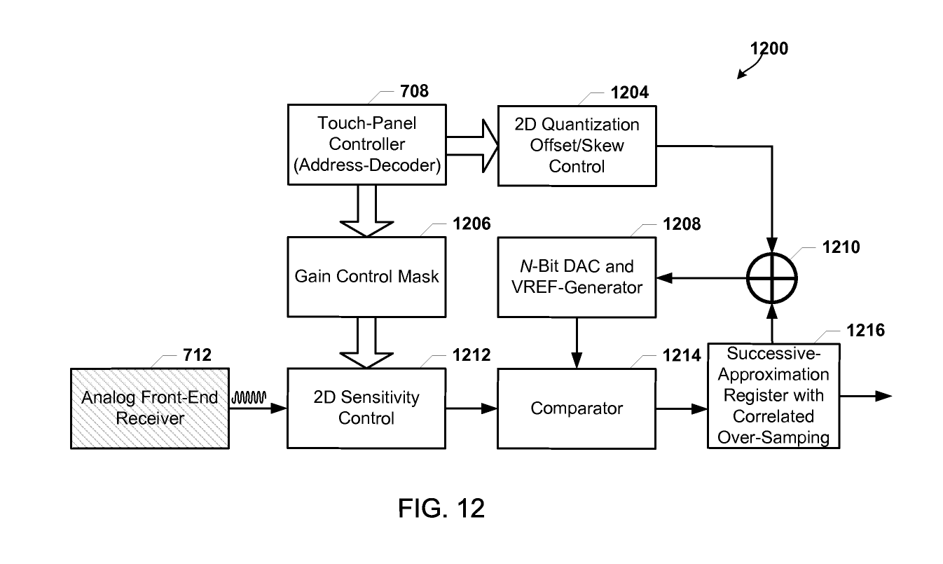

FIG. 12 illustrates a component block diagram of a transducer front end system 1200 for calibrating a digital touch signal. In an aspect, a touchscreen controller may perform method 900. However, one of ordinary skill in the art would appreciate that another processor (e.g., a host processor) may perform the actions of method 900.

A 2D sensitivity control 1212 may receive an analog touch signal from an analog front-end receiver 712. The 2D sensitivity control 1212 may be configured to apply gains received from a gain control mask 1206, which may be configured to receive gain levels that a touchscreen controller 708 set to enhance the signal-to-noise ratio. The 2D sensitivity control 1212 may be in communication with a comparator 1214 that is configured to compare the value of the analog touch signal against a reference value. For example, the comparator 1214 may receive an analog touch signal in the form of a voltage value and may compare this value against a reference voltage value V_{REF} to determine which value is larger. The comparator 1214 may be configured to work in conjunction with a successive-approximation register 1216, an n-bit digital-to-analog converter and V_{REF} generator 1208. The successive-approximation register 1216 may store an approximation of the analog touch signal's value and may send that approximation as a digital approximation signal to an adder module 1210. The adder module 1210 may also be configured to receive offset and skewing data from a 2D quantization offset/skew control 1204, which may receive instructions for how to skew a touch signal from a touchscreen controller 708. In another aspect, a host processor may send calibration parameters (i.e., instructions) to the 2D quantization offset/skew control 1204 to skew or calibrate the digital approximation from the successive-approximation register 1216 at the adder module 1210. For example, the digital approximation may be increased or decreased, as appropriate, to mitigate noise.

The 2D quantization offset/skew control 1204 may also be configured to send skewing data that converts a touch signal into a calibrated form. For example, if the touch signal received from the touchscreen panel consistently indicates that one row has a higher or lower voltage value even when there is no touch occurring, the 2D quantization offset/skew control 1204 may send skewing data to correct the errant row. In a further aspect, the 2D quantization offset/skew control 1204 may skew and/or convert a touch signal into a form that a host processor may use directly.

The adder module 1210 may be configured to send the skewed digital touch signal approximation to the n-bit digital-to-analog converter and V_{REF} generator 1208, where the digital touch signal approximation is converted to an skewed analog signal. The n-bit digital-to-analog converter and V_{REF} generator 1208 may be configured to send the reference value and the converted skewed analog signal to the comparator 1214, where the values are compared to determine which value is larger. The comparator 1214 may send this determination to the successive-approximation register 1216 until. The successive-approximation register 1216 may continue to send digital approximations (which may continue to be skewed, as appropriate) until a certain threshold is met. This threshold may include requiring a certain amount of over-sampling of the input analog touch signal and a certain approximation requirement. The successive-approximation register 1216 may then output a skewed digital approximation of the analog touch signal for further processing.

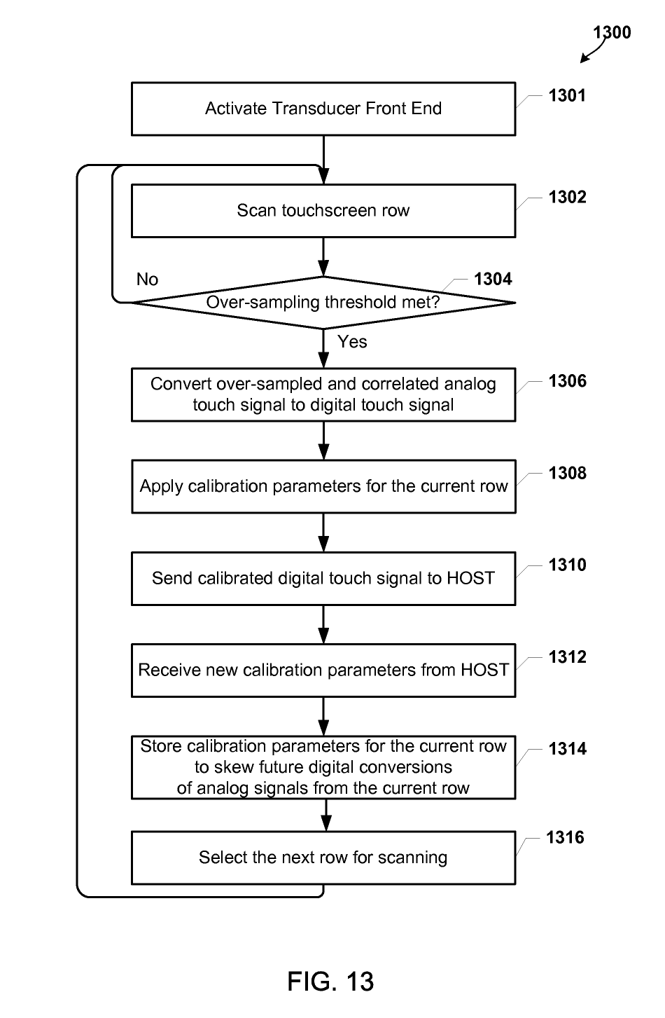

FIG. 13 illustrates an aspect transducer front end method 1300 for skewing analog touch signals based on a host processor's calibration feedback. In block 1301, a transducer front end may be activated. For example, the transducer front end may be configured to receive an interrupt signal from a touchscreen controller or a host processor that wakes the transducer front end from an inactive state. Once activated, the transducer front end may scan a row on the touchscreen in block 1302. At determination block 1304, the transducer front end may determine whether an over-sampling threshold is met. For example, the host processor or touchscreen controller may require the transducer front end to receive multiple samples from each row to ensure the integrity of the touch signal. If the over-sampling threshold is not met (i.e., determination block 1304=“No”), the transducer front end may continue operating in block 1302. Otherwise (i.e., determination block 1304=“Yes”), the transducer front-end may convert the over-sampled and correlated analog touch signal to a digital touch signal in block 1306. The conversion of the analog touch signal to a digital approximation may be performed by a successive-approximation register (i.e., an analog-to-digital converter) as described above with reference to FIG. 12. The transducer front end may also apply calibration parameters for the current row in block 1308. In an aspect, the calibration parameters may instruct the transducer front end to adjust the digital approximation of the analog touch signal sent from the successive-approximation register (i.e., skew the digital approximation from the analog-to-digital signal converter). For example, the calibration parameters may configure the transducer front end to apply gains to the digital approximation of the touch signal to account for noise that the transducer's environment introduces into the analog touch signal.

The transducer front end may send the calibrated digital touch signal to the host processor in block 1310. The host processor may receive the calibrated digital touch signal and process the calibrated digital touch signal. For example, the host processor may perform various techniques to determine whether a valid touch input was received. In another example, the host processor may process the calibrated digital touch signal to determine gestures or other information applications operating on the touchscreen computing device may use. In block 1312, the transducer front end may receive new calibration parameters from the host processor. These new calibration parameters may reflect additional errors or inaccuracies the host processor encountered while processing the calibrated digital touch signal. For example, the host processor may have determined that the touch input represented by the touch signal was noise.

On receiving the new calibration parameters, the transducer front end may store these calibration parameters for the current row in block 1314 to skew future scans of the current row. For example, the transducer may apply these new calibration parameters for the current row in block 1308 the next time the current row is scanned. The transducer front end may also select the next row on the touchscreen panel for scanning in block 1316. The transducer front end may continue operating in block 1302.

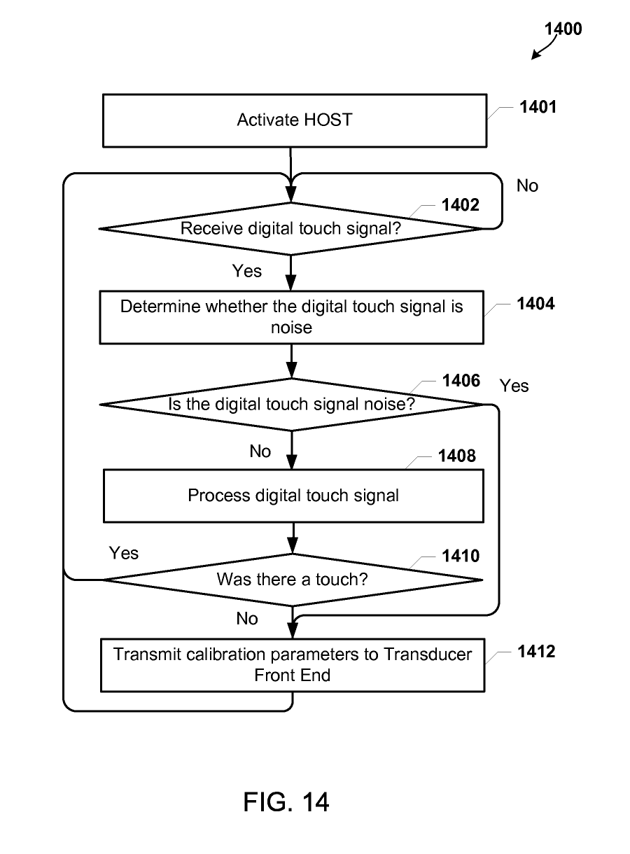

FIG. 14 illustrates an aspect method 1400 for a host processor sending calibration feedback directly to a transducer front end. In block 1401, a host processor may activate. For example, the host processor may receive an interrupt signal indicating that touch inputs have been detected on the touchscreen panel. As another example, the host processor may receive an interrupt signal indicating that touchscreen touch inputs are available from a transducer front end. In an aspect, the host processor may periodically monitor for receipt of touchscreen touch inputs in a buffer (e.g., check for incoming signals once every millisecond). In determination block 1402, the host processor may determine whether it has received a digital touch signal. A transducer front end may, for example, send a digital touch signal to the host processor as discussed above with reference to FIG. 13.

If the host processor has not received a digital touch signal (i.e., determination block 1402=“No”), the host processor may continue operating in determination block 1402. Otherwise (i.e., determination block 1402=“Yes”), the host processor may further determine whether the digital touch signal is noise. The host processor may perform various de-noising and signal enhancement to the digital touch signal and may compensate for noise generated as a result of the transducer's location in the touchscreen computing device. For example, the host processor may apply gains to the digital touch signal in block 1404 to enhance the signal-to-noise ratio, making it easier to extract a desired touch signal, if present. In determination block 1406, if the host processor determines that the digital touch signal is noise (i.e., determination block 1406=“Yes”), then the host processor may transmit calibration parameters to the transducer front end in block 1412. The calibration parameters may be instructions for the transducer front end to skew signals from scans of a particular row on the touchscreen panel to calibrate the signals read from that row to mirror properly functioning rows, thereby mitigating future instances of false touch reports. In an aspect, the calibration parameters may configure the transducer front end to calibrate the digital approximations generated by the successive approximation register 1216 as discussed above with reference to FIG. 13. For instance, the host processor's calibration parameters may configure the transducer front end to subtract from the digital approximation sent by the successive approximation register 1216 to account for a noise that is consistently present when scanning a particular row.

If the host processor determines that the digital touch signal is not noise (i.e., determination block 1406=“No”), the host processor may process the digital touch signal at 1408. The host processor may perform various signal processing techniques, including detecting touch primitives, tracking touch primitives, and identifying symbols and gestures. The host processor may also convert the digital touch signal into a form that applications running on the touchscreen computing device can use, and the host processor may receive indications from whether the processed touch signal seemed to indicate an actual touch. In processing the digital touch signal, the host processor may also receive information from other sensors and applications regarding the likelihood that a touch actually occurred. If the host processor determines that a touch actually occurred (i.e., determination block 1410=“Yes”), the host processor may continue operating in determination block 1402. Otherwise (determination 1410=“No”), the host processor may transmit calibration parameters to the transducer front end in block 1412. These calibration parameters may be instructions for how the transducer front end may adjust the digital approximation of a touch signal sent by the successive approximation register 1216 to skew rows scanned in the future to avoid sending false touch signals or other noise as described above with reference to FIG. 13. The host processor may continue to operate in determination block 1402.

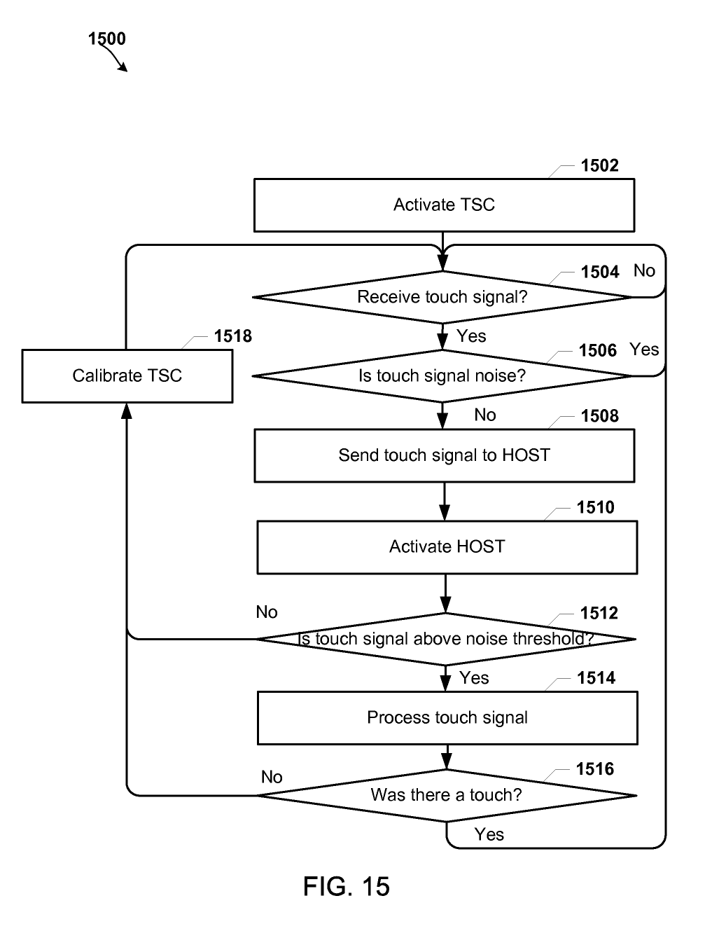

FIG. 15 is a process flow diagram illustrating an aspect method 1500 for a host processor sending calibration feedback of a touch signal to a touchscreen controller. In block 1502, the touchscreen controller may activate or be configured to received in response to detected touch inputs on the touchscreen panel. For example, the touchscreen computing device may utilize a data path that includes transmitting signals (e.g., touchscreen touch inputs) from a touchscreen panel to an analog front end circuit, to a data binning component, to quantizer and integrator components, and finally to the touchscreen controller for further processing.

In determination block 1504, the touchscreen controller may determine whether it has received a touch signal. For example, the touchscreen controller may receive a touch signal from a transducer front end. If the touchscreen controller has not received a touch signal (i.e., determination block 1504=“No”), then the touchscreen controller may continue operating in determination block 1504. Otherwise (i.e., determination block 1504=“Yes”), the touchscreen controller may determine whether the received touch signal is noise. The touchscreen controller may use various techniques to make this determination, including performing de-noising and signal enhancement. If the touchscreen controller determines that the touch signal is noise (i.e., determination block 1506=“Yes”), the touchscreen controller may continue operating in determination block 1504. Otherwise (i.e., determination block 1506=“No”), the touchscreen controller may send the touch signal to the host processor in block 1508. In block 1510, the host processor may activate or be configured to receive a touch signal in response to detected touch inputs on the touchscreen panel. For example, the touchscreen computing device may utilize a data path that includes transmitting signals (e.g., touchscreen touch inputs) from a touchscreen panel to an analog front end circuit, to a data binning component, to quantizer and integrator components, to a touchscreen controller, and finally to the host processor for further processing.

In determination block 1512, the host processor may determine whether a touch signal is above a particular noise threshold. In other words, the host processor may conduct its own assessment of whether the touch signal sent from the transducer front end represents an actual touch or just noise. The host processor's independent noise assessment may be more accurate because of the host processor's greater signal processing capabilities. If the host processor determines that the touch signal is not above a certain noise threshold (i.e., determination block 1512=“No”), then the host processor may calibrate the touchscreen controller in block 1518. The host processor may, for example, send information and instructions to the touchscreen controller that may allow the touchscreen controller to recognize noise or other false touch indicators more effectively. In another example, the host processor may send calibration parameters to the touchscreen controller, and the touch screen controller may communicate those calibration parameters to a transducer front end. The calibration parameters may configure the transducer front end to skew the digital approximation sent from the successive approximation register 1216 to account for noise.

If the host processor determines that a touch signal is above a certain noise threshold (i.e., determination block 1512=“Yes”), the host processor may further process the touch signal in block 1514. In block 1514, the host processor may process the touch signal data, and may utilize the processed data in combination with other applications executing on the host processor. For example, the host processor may intermittently perform operations to execute an application (e.g., an email client with GUI) and process touch signal data relating to the application. For example, the host processor may transform the touch signal into a form that applications running on the touchscreen computing device may use, such as converting the touch signal into coordinates on the display corresponding to a user's input. The host processor may also receive information from sensors and applications running on the touchscreen computing device that may indicate a greater or lesser likelihood that a touch actually occurred. For example, if the host processor received a signal that barely surpasses the noise threshold, and that signal corresponds to a touch on an area of the touchscreen where no graphics are rendered, the host processor may decide that there was no actual touch. If the host processor determines that a touch actually occurred (i.e., determination block 1516=“Yes”), the operations may continue in determination block 1504. Otherwise (i.e., determination block 1516=“No”), the host processor may calibrate the touchscreen controller in block 1518. These calibrations may include information for or instructions to the touchscreen controller that enhance the touchscreen controller's ability to discriminate touch signals that represent actual touches from those that represent false touches. Operations may then continue in determination block 1504.

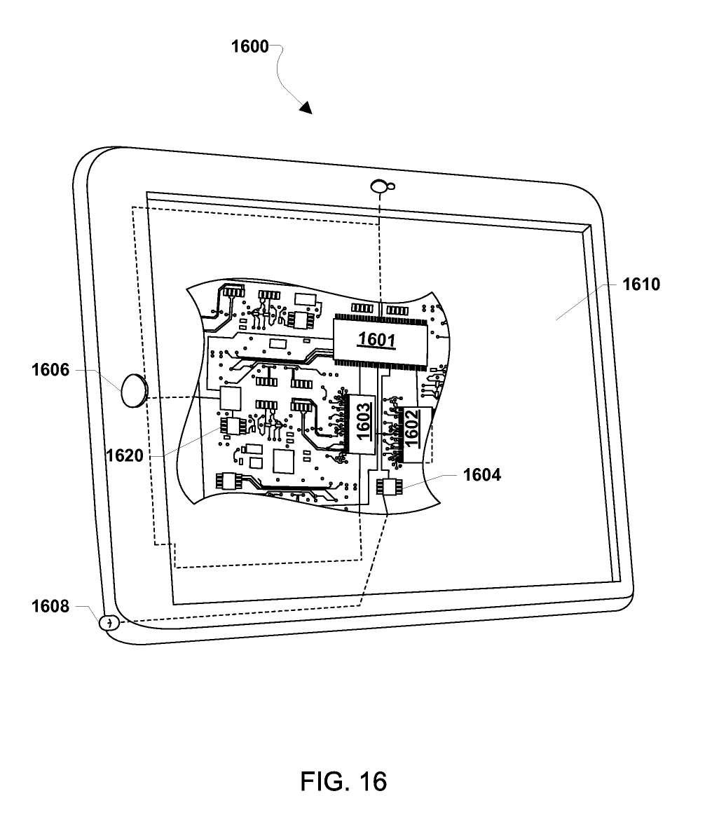

The various aspects may be implemented in any of a variety of tablet devices, an example of which is illustrated in FIG. 16. For example, the tablet device 1600 may include a touchscreen controller 1603 and a host processor 1601 coupled to internal memory 1602. The internal memory 1602 may be volatile or non-volatile memory, and may also be secure and/or encrypted memory, or unsecure and/or unencrypted memory, or any combination thereof. The touchscreen controller 1603 and processor 1601 may also be coupled to a touchscreen panel 1610, such as a resistive-sensing touchscreen, capacitive-sensing touchscreen infrared sensing touchscreen, etc. The tablet device 1600 may have one or more short-range radio signal transceivers 1604 (e.g., Peanut®, Bluetooth®, Zigbee®, RF radio) and antennae 1608 for sending and receiving wireless signals as described herein. The transceivers 1604 and antennae 1608 may be used with the above-mentioned circuitry to implement the various wireless transmission protocol stacks and interfaces. The tablet device 1600 may include a cellular network wireless modem chip 1620 that enables communication via a cellular network. The tablet device 1600 may also include a physical button 1606 for receiving user inputs.

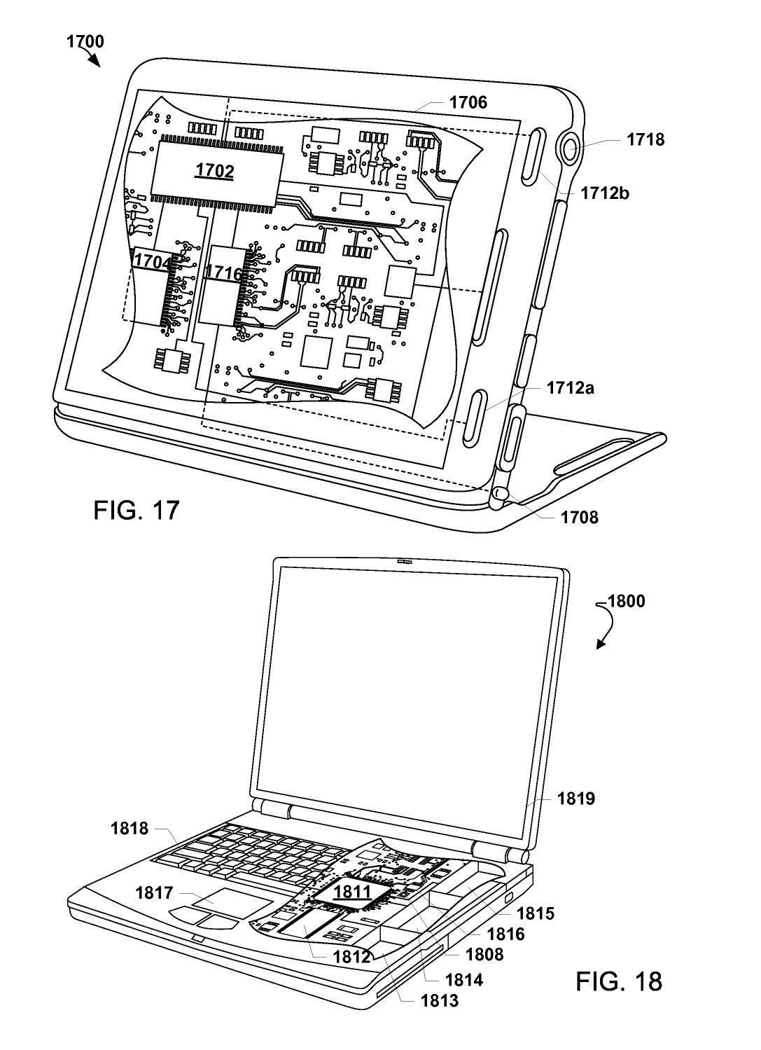

The various aspects may be implemented in any of a variety of mobile devices, an example of which is illustrated in FIG. 17. For example, the mobile device 1700 may include a host processor 1702 coupled to internal memory 1704. Internal memory 1704 may be volatile or non-volatile memory, and may also be secure and/or encrypted memory, or unsecure and/or unencrypted memory, or any combination thereof. The host processor 1702 may also be coupled to a touchscreen panel 1706, such as a resistive-sensing touchscreen, capacitive-sensing touchscreen infrared sensing touchscreen, or the like. Additionally, the display of the mobile device 1700 need not have touchscreen capability. Additionally, the mobile device 1700 may have one or more antenna 1708 for sending and receiving electromagnetic radiation that may be connected to a wireless data link and/or cellular telephone transceiver 1716 coupled to the processor 1702. The mobile device 1700 may also include physical buttons 1712a and 1712b for receiving user inputs. The mobile device 1700 may also include a power button 1718 for turning the mobile device 1700 on and off.

The various aspects described above may also be implemented within a variety of mobile devices, such as a laptop computer 1800 illustrated in FIG. 18. Many laptop computers include a touch pad touch surface 1817 that serves as the computer's pointing device, and thus may receive drag, scroll, and flick gestures similar to those implemented on mobile computing devices equipped with a touchscreen panel and described above. A laptop computer 1800 will typically include a processor 1811 coupled to volatile memory 1812 and a large capacity nonvolatile memory, such as a disk drive 1813 of Flash memory. Additionally, the computer 1800 may have one or more antenna 1808 for sending and receiving electromagnetic radiation that may be connected to a wireless data link transceiver 1816 coupled to the processor 1811. The computer 1800 may also include a floppy disc drive 1814 and a compact disc (CD) drive 1815 coupled to the processor 1811. In a notebook configuration, the computer housing includes the touchpad 1817, the keyboard 1818, and the display 1819 all coupled to the processor 1811. Other configurations of the computing device may include a computer mouse or trackball coupled to the processor (e.g., via a USB input) as are well known, which may also be use in conjunction with the various aspects.

The foregoing method descriptions and the process flow diagrams are provided merely as illustrative examples and are not intended to require or imply that the steps of the various aspects must be performed in the order presented. As will be appreciated by one of skill in the art the order of steps in the foregoing aspects may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method of processing a touch signal from a transducer front end of a computing device comprising a touchscreen panel, comprising processing the touch signal jointly by a touchscreen controller and a host processor.

2. The method of claim 1, wherein processing the touch signal jointly by the touchscreen controller and the host processor comprises:
receiving the touch signal on the host processor; and
determining whether a valid touch input occurred with the host processor.

3. The method of claim 2, further comprising processing the touch signal by the host processor without contribution from the touchscreen controller.

4. The method of claim 2, further comprising using information from an application executing on the host processor to determine whether the touch signal is a valid touch input.

5. The method of claim 2, further comprising using information from a sensor communicating data to the host processor to determine whether the touch signal is a valid touch input.

6. The method of claim 2, further comprising:
receiving the touch signal in the touchscreen controller;
determining in the touchscreen controller whether a valid touch input occurred;
comparing the valid touch input determinations made by the host processor and the touchscreen controller; and
finding a valid touch input occurred based on the compared valid touch input determinations.

7. The method of claim 6, further comprising using information from an application executing on the host processor to determine whether the touch signal is a valid touch input.

8. The method of claim 6, further comprising using information from a sensor communicating data to the host processor to determine whether the touch signal is a valid touch input.

9. The method of claim 2, further comprising updating a touch-processing state based on an outcome of determining whether a valid touch input occurred.

10. The method of claim 9, further comprising updating a touchscreen-scanning setting.

11. The method of claim 10, wherein updating the touchscreen-scanning setting comprises adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

12. The method of claim 11, further comprising:
maximizing the touch resolution in response to an “active” setting;
minimizing the touch resolution in response to a “standby” setting;
setting a mid-range touch resolution in response to a “semi-active” setting; and
disabling the touchscreen panel in response to a “sleep” setting.

13. The method of claim 12, wherein minimizing the touch resolution in response to a “standby” setting comprises:
aggregating all rows in the touchscreen area;
aggregating all columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns.

14. The method of claim 12, wherein maximizing the touch resolution in response to an “active” setting comprises:
separating rows in the touchscreen area;
separating columns in the touchscreen area;
adjusting a drive strength of an electronic signal sent through the touchscreen area to allow for scanning individual rows and columns; and
performing future scans of the touchscreen area for touches on individual rows and individual columns.

15. The method of claim 12, wherein setting the mid-range touch resolution in response to a “semi-active” setting comprises:
aggregating a plurality of rows in the touchscreen area;
aggregating a plurality of columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

16. The method of claim 12, wherein disabling the touchscreen panel in response to a “sleep” setting comprises:
disabling the touchscreen area;
reducing a drive strength of a electronic signal sent through the touchscreen area to allow for no scanning; and
not performing scans of the touchscreen area.

17. The method of claim 2, further comprising sending calibration parameters to the transducer front end in response to an invalid touch input.

18. The method of claim 17, further comprising storing calibration parameters for use in calibrating a future touch signal.

19. The method of claim 17, wherein calibration parameters configure the transducer front end to calibrate a future touch signal sent from a touchscreen panel for use by the host processor.

20. The method of claim 19, wherein calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

21. A touchscreen computing device, comprising means for processing a touch signal jointly by a touchscreen controller and a host processor from a transducer front end of a computing device comprising a touchscreen panel.

22. The touchscreen computing device of claim 21, wherein means for processing the touch signal jointly by the touchscreen controller and the host processor comprises:
means for receiving the touch signal on the host processor; and
means for determining with the host processor whether a valid touch input occurred.

23. The touchscreen computing device of claim 22, further comprising means for processing the touch signal by the host processor without contribution from the touchscreen controller.

24. The touchscreen computing device of claim 22, further comprising means for using information from an application executing on the host processor to determine whether the touch signal is a valid touch input.

25. The touchscreen computing device of claim 22, further comprising means for using information from a sensor communicating data to the host processor to determine whether the touch signal is a valid touch input.

26. The touchscreen computing device of claim 22, further comprising:
means for receiving the touch signal in the touchscreen controller;
means for determining in the touchscreen controller whether a valid touch input occurred;
means for comparing the valid touch input determinations made by the host processor and the touchscreen controller; and
means for finding a valid touch input occurred based on the compared valid touch input determinations.

27. The touchscreen computing device of claim 26, further comprising means for using information from an application executing on the host processor to determine whether the touch signal is a valid touch input.

28. The touchscreen computing device of claim 26, further comprising means for using information from a sensor communicating data to the host processor to determine whether the touch signal is a valid touch input.

29. The touchscreen computing device of claim 22, further comprising means for updating a touch-processing state based on an outcome of determining whether a valid touch input occurred.

30. The touchscreen computing device of claim 29, further comprising means for updating a touchscreen-scanning setting.

31. The touchscreen computing device of claim 30, wherein means for updating the touchscreen-scanning setting comprises means for adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

32. The touchscreen computing device of claim 31, further comprising:
means for maximizing the touch resolution in response to an “active” setting;
means for minimizing the touch resolution in response to a “standby” setting;
means for setting a mid-range touch resolution in response to a “semi-active” setting; and
means for disabling the touchscreen panel in response to a “sleep” setting.

33. The touchscreen computing device of claim 32, wherein means for minimizing the touch resolution in response to a “standby” setting comprises:
means for aggregating all rows in the touchscreen area;
means for aggregating all columns in the touchscreen area;
means for adjusting a drive strength of a electronic signal sent through the touchscreen area to allow for scanning the aggregated rows and aggregated columns; and
means for performing future scans of the touchscreen area for touches on the aggregated rows and the aggregated columns.

34. The touchscreen computing device of claim 32, wherein means for maximizing the touch resolution in response to an “active” setting comprises:
means for separating rows in the touchscreen area;
means for separating columns in the touchscreen area;
means for adjusting a drive strength of an electronic signal sent through the touchscreen area to allow for scanning individual rows and columns; and
means for performing future scans of the touchscreen area for touches on individual rows and individual columns.

35. The touchscreen computing device of claim 32, wherein means for setting the mid-range touch resolution in response to a “semi-active” setting comprises:
means for aggregating a plurality of rows in the touchscreen area;
means for aggregating a plurality of columns in the touchscreen area;
means for adjusting a drive strength of a electronic signal sent through the touchscreen area to allow for scanning the aggregated rows and aggregated columns; and
means for performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

36. The touchscreen computing device of claim 32, wherein means for disabling the touchscreen panel in response to a “sleep” setting comprises:
means for disabling the touchscreen area;
means for reducing a drive strength of a electronic signal sent through the touchscreen area to allow for no scanning; and
means for not performing scans of the touchscreen area.

37. The touchscreen computing device of claim 22, further comprising means for sending calibration parameters to the transducer front end in response to an invalid touch input.

38. The touchscreen computing device of claim 37, further comprising means for storing calibration parameters for use in calibrating a future touch signal.

39. The touchscreen computing device of claim 37, wherein calibration parameters configure the transducer front end to calibrate a future touch signal sent from a touchscreen panel for use by the host processor.

40. The touchscreen computing device of claim 39, wherein calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

41. A touchscreen computing device, comprising:
a touchscreen panel;
a touchscreen controller coupled to the touchscreen panel; and
a host processor coupled to the touchscreen controller and the touchscreen panel,
wherein the touchscreen controller is configured with processor-executable instructions to perform operations comprising:
receiving a touch signal;
determining whether a valid touch input occurred; and
processing the touch signal jointly with the host processor, and
wherein the host processor is configured with processor-executable instructions to perform operations comprising:
receiving a touch signal;
determining whether a valid touch input occurred; and
processing the touch signal jointly with the touchscreen controller.

42. The touchscreen computing device of claim 41, wherein the host processor is configured with processor-executable instructions to perform operations further comprising using information from an application executing on the host processor to determine whether the touch signal is a valid touch input.

43. The touchscreen computing device of claim 41, wherein the host processor is configured with processor-executable instructions to perform operations further comprising using information from a sensor communicating data to the host processor to determine whether the touch signal is a valid touch input.

44. The touchscreen computing device of claim 41, wherein the host processor is configured with processor-executable instructions to perform operations further comprising processing the touch signal without contribution from the touchscreen controller.

45. The touchscreen computing device of claim 41, wherein the host processor is configured with processor-executable instructions to perform operations further comprising:
comparing the valid touch input determinations made by the host processor and the touchscreen controller; and
finding a valid touch input occurred based on the compared valid touch input determinations.

46. The touchscreen computing device of claim 45, wherein the host processor is configured with processor-executable instructions to perform operations further comprising using information from an application executing on the host processor to determine whether the touch signal is a valid touch input.

47. The touchscreen computing device of claim 45, wherein the host processor is configured with processor-executable instructions to perform operations further comprising using information from a sensor communicating data to the host processor to determine whether the touch signal is a valid touch input.

48. The touchscreen computing device of claim 41, wherein the host processor is configured with processor-executable instructions to perform operations further comprising updating a touch-processing state based on an outcome of determining whether a valid touch input occurred.

49. The touchscreen computing device of claim 48, wherein the host processor is configured with processor-executable instructions to perform operations further comprising updating a touchscreen-scanning setting.

50. The touchscreen computing device of claim 49, wherein the host processor is configured with processor-executable instructions to perform operations such that updating the touchscreen-scanning setting comprises adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of the touchscreen panel.

51. The touchscreen computing device of claim 50, wherein the host processor is configured with processor-executable instructions to perform operations further comprising:
maximizing the touch resolution in response to an “active” setting;
minimizing the touch resolution in response to a “standby” setting;
setting a mid-range touch resolution in response to a “semi-active” setting; and
disabling the touchscreen panel in response to a “sleep” setting.

52. The touchscreen computing device of claim 51, wherein the host processor is configured with processor-executable instructions to perform operations such that minimizing the touch resolution in response to a “standby” setting comprises:
aggregating all rows in the touchscreen area;
aggregating all columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns.

53. The touchscreen computing device of claim 51, wherein the host processor is configured with processor-executable instructions to perform operations such that maximizing the touch resolution in response to an “active” setting comprises:
separating rows in the touchscreen area;
separating columns in the touchscreen area;
adjusting a drive strength of an electronic signal sent through the touchscreen area to allow for scanning individual rows and columns; and
performing future scans of the touchscreen area for touches on individual rows and individual columns.

54. The touchscreen computing device of claim 51, wherein the host processor is configured with processor-executable instructions to perform operations such that setting the mid-range touch resolution in response to a “semi-active” setting comprises:
aggregating a plurality of rows in the touchscreen area;
aggregating a plurality of columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

55. The touchscreen computing device of claim 51, wherein the host processor is configured with processor-executable instructions to perform operations further comprising such that disabling the touchscreen panel in response to a “sleep” setting comprises:
disabling the touchscreen area;
reducing a drive strength of a electronic signal sent through the touchscreen area to allow for no scanning; and
not performing scans of the touchscreen area.

56. The touchscreen computing device of claim 41, wherein the host processor is configured with processor-executable instructions to perform operations further comprising sending calibration parameters to the transducer front end in response to an invalid touch input.

57. The touchscreen computing device of claim 56, wherein the host processor is configured with processor-executable instructions to perform operations further comprising storing calibration parameters for use in calibrating a future touch signal.

58. The touchscreen computing device of claim 56, wherein the host processor is configured with processor-executable instructions to perform operations such that calibration parameters configure the transducer front end to calibrate a future touch signal sent from a touchscreen panel for use by the host processor.

59. The touchscreen computing device of claim 58, wherein the host processor is configured with processor-executable instructions to perform operations such that calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

60. A non-transitory processor-readable storage medium having stored thereon processor executable instructions configured to cause a host processor of a touchscreen computing device to perform operations comprising processing a touch signal from a transducer front end of a computing device comprising a touchscreen panel jointly with a touchscreen controller.

61. The non-transitory processor-readable storage medium of claim 60, wherein the stored processor-executable instructions are configured to cause a host processor of a touchscreen computing device to perform operations such that processing the touch signal from the transducer front end of the touchscreen jointly with the touchscreen controller comprises:
receiving the touch signal; and
determining whether a valid touch input occurred.

62. The non-transitory processor-readable storage medium of claim 61, wherein the stored processor-executable instructions are configured to cause a host processor of a touchscreen computing device to perform operations further comprising processing the touch signal without contribution from the touchscreen controller.

63. The non-transitory processor-readable storage medium of claim 61, wherein the stored processor-executable instructions are configured to cause a host processor of a touchscreen computing device to perform operations further comprising using information from an application executing on the host processor to determine whether the touch signal is a valid touch input.

64. The non-transitory processor-readable storage medium of claim 61, wherein the stored processor-executable instructions are configured to cause a host processor of a touchscreen computing device to perform operations further comprising using information from a sensor communicating data to the host processor to determine whether the touch signal is a valid touch input.

65. The non-transitory processor-readable storage medium of claim 61, wherein the stored processor-executable instructions are configured to cause a host processor of a touchscreen computing device to perform operations further comprising:
comparing the valid touch input determinations made by the host processor and the touchscreen controller; and
finding a valid touch input occurred based on the compared valid touch input determinations.

66. The non-transitory processor-readable storage medium of claim 65, wherein the stored processor-executable instructions are configured to cause a host processor of a touchscreen computing device to perform operations further comprising using information from an application executing on the host processor to determine whether the touch signal is a valid touch input.

67. The non-transitory processor-readable storage medium of claim 65, wherein the stored processor-executable instructions are configured to cause a host processor of a touchscreen computing device to perform operations further comprising using information from a sensor communicating data to the host processor to determine whether the touch signal is a valid touch input.

68. The non-transitory processor-readable storage medium of claim 61, wherein the stored processor-executable instructions are configured to cause a host processor of a touchscreen computing device to perform operations further comprising updating a touch-processing state based on an outcome of determining whether a valid touch input occurred.

69. The non-transitory processor-readable storage medium of claim 68, wherein the stored processor-executable instructions are configured to cause a host processor of a touchscreen computing device to perform operations further comprising updating a touchscreen-scanning setting.

70. The non-transitory processor-readable storage medium of claim 69, wherein the stored processor-executable instructions are configured to cause a host processor of a touchscreen computing device to perform operations such that updating the touchscreen-scanning setting comprises adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

71. The non-transitory processor-readable storage medium of claim 70, wherein the stored processor-executable instructions are configured to cause a host processor of a touchscreen computing device to perform operations further comprising:
maximizing the touch resolution in response to an “active” setting;
minimizing the touch resolution in response to a “standby” setting;
setting a mid-range touch resolution in response to a “semi-active” setting; and
disabling the touchscreen panel in response to a “sleep” setting.

72. The non-transitory processor-readable storage medium of claim 71, wherein the stored processor-executable instructions are configured to cause a host processor of a touchscreen computing device to perform operations further comprising such that minimizing the touch resolution in response to a “standby” setting comprises:
aggregating all rows in the touchscreen area;
aggregating all columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns.

73. The non-transitory processor-readable storage medium of claim 71, wherein the stored processor-executable instructions are configured to cause a host processor of a touchscreen computing device to perform operations such that maximizing the touch resolution in response to an “active” setting comprises:
separating rows in the touchscreen area;
separating columns in the touchscreen area;
adjusting a drive strength of an electronic signal sent through the touchscreen area to allow for scanning individual rows and columns; and
performing future scans of the touchscreen area for touches on individual rows and individual columns.

74. The non-transitory processor-readable storage medium of claim 71, wherein the stored processor-executable instructions are configured to cause a host processor of a touchscreen computing device to perform operations such that setting the mid-range touch resolution in response to a “semi-active” setting comprises:
aggregating a plurality of rows in the touchscreen area;
aggregating a plurality of columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

75. The non-transitory processor-readable storage medium of claim 71, wherein the stored processor-executable instructions are configured to cause a host processor of a touchscreen computing device to perform operations such that disabling the touchscreen panel in response to a “sleep” setting comprises:
disabling the touchscreen area;
reducing a drive strength of a electronic signal sent through the touchscreen area to allow for no scanning; and
not performing scans of the touchscreen area.

76. The non-transitory processor-readable storage medium of claim 61, wherein the stored processor-executable instructions are configured to cause a host processor of a touchscreen computing device to perform operations further comprising sending calibration parameters to the transducer front end in response to an invalid touch input.

77. The non-transitory processor-readable storage medium of claim 76, wherein the stored processor-executable instructions are configured to cause a host processor of a touchscreen computing device to perform operations further comprising storing calibration parameters for use in calibrating a future touch signal.

78. The non-transitory processor-readable storage medium of claim 76, wherein the stored processor-executable instructions are configured to cause a host processor of a touchscreen computing device to perform operations such that calibration parameters configure the transducer front end to calibrate a future touch signal sent from a touchscreen panel for use by the host processor.

79. The non-transitory processor-readable storage medium of claim 78, wherein the stored processor-executable instructions are configured to cause a host processor of a touchscreen computing device to perform operations such that calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

80. A host processor configured for use with a touchscreen computing device, wherein the host processor is configured with processor-executable instructions to perform operations comprising processing a touch signal from a transducer front end of a computing device comprising a touchscreen panel, comprising processing the touch signal jointly with a touchscreen controller.

81. The host processor of claim 80, wherein the host processor is configured with processor-executable instructions to perform operations further comprising:
receiving the touch signal; and
determining whether a valid touch input occurred.

82. The host processor of claim 81, wherein the host processor is configured with processor-executable instructions to perform operations further comprising using information from an application executing on the host processor to determine whether the touch signal is a valid touch input.

83. The host processor of claim 81, wherein the host processor is configured with processor-executable instructions to perform operations further comprising using information from a sensor communicating data to the host processor to determine whether the touch signal is a valid touch input.

84. The host processor of claim 81, wherein the host processor is configured with processor-executable instructions to perform operations further comprising processing the touch signal without contribution from the touchscreen controller.

85. The host processor of claim 81, wherein the host processor is configured with processor-executable instructions to perform operations further comprising:
comparing a valid-touch-input determination of the host processor and a valid-touch-input determination of the touchscreen controller; and
finding a valid touch input occurred based on the compared valid touch input determinations.

86. The host processor of claim 81, wherein the host processor is configured with processor-executable instructions to perform operations further comprising updating a touch-processing state based on an outcome of determining whether a valid touch input occurred.

87. The host processor of claim 86, wherein the host processor is configured with processor-executable instructions to perform operations further comprising updating a touchscreen-scanning setting.

88. The host processor of claim 87, wherein the host processor is configured with processor-executable instructions to perform operations such that updating the touchscreen-scanning setting comprises adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

89. The host processor of claim 88, wherein the host processor is configured with processor-executable instructions to perform operations further comprising:
maximizing the touch resolution in response to an “active” setting;
minimizing the touch resolution in response to a “standby” setting;
setting a mid-range touch resolution in response to a “semi-active” setting; and
disabling the touchscreen panel in response to a “sleep” setting.

90. The host processor of claim 89, wherein the host processor is configured with processor-executable instructions to perform operations such that minimizing the touch resolution in response to a “standby” setting comprises:
aggregating all rows in the touchscreen area;
aggregating all columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns.

91. The host processor of claim 89, wherein the host processor is configured with processor-executable instructions to perform operations such that maximizing the touch resolution in response to an “active” setting comprises:
separating rows in the touchscreen area;
separating columns in the touchscreen area;
adjusting a drive strength of an electronic signal sent through the touchscreen area to allow for scanning individual rows and columns; and
performing future scans of the touchscreen area for touches on individual rows and individual columns.

92. The host processor of claim 89, wherein the host processor is configured with processor-executable instructions to perform operations such that setting the mid-range touch resolution in response to a “semi-active” setting comprises:
aggregating a plurality of rows in the touchscreen area;
aggregating a plurality of columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

93. The host processor of claim 89, wherein the host processor is configured with processor-executable instructions to perform operations further comprising such that disabling the touchscreen panel in response to a “sleep” setting comprises:
disabling the touchscreen area;
reducing a drive strength of a electronic signal sent through the touchscreen area to allow for no scanning; and
not performing scans of the touchscreen area.

94. The host processor of claim 81, wherein the host processor is configured with processor-executable instructions to perform operations further comprising sending calibration parameters to the transducer front end in response to an invalid touch input.

95. The host processor of claim 94, wherein the host processor is configured with processor-executable instructions to perform operations further comprising storing calibration parameters for use in calibrating a future touch signal.

96. The host processor of claim 94, wherein the host processor is configured with processor-executable instructions to perform operations such that calibration parameters configure the transducer front end to calibrate a future touch signal sent from a touchscreen panel for use by the host processor.

97. The host processor of claim 96, wherein the host processor is configured with processor-executable instructions to perform operations such that calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

98. A host processor for use with a touchscreen computing device, comprising means for processing a touch signal from a transducer front end of a computing device comprising a touchscreen panel jointly with a touchscreen controller.

99. The host processor of claim 98, wherein means for processing a touch signal from a transducer front end of a computing device comprising a touchscreen panel jointly with a touchscreen controller comprises:
means for receiving the touch signal; and
means for determining whether a valid touch input occurred.

100. The host processor of claim 99, further comprising means for using information from an application executing on the host processor to determine whether the touch signal is a valid touch input.

101. The host processor of claim 99, further comprising means for using information from a sensor communicating data to the host processor to determine whether the touch signal is a valid touch input.

102. The host processor of claim 99, further comprising means for processing the touch signal by the host processor without contribution from the touchscreen controller.

103. The host processor of claim 99, further comprising means for updating a touch-processing state based on an outcome of determining whether a valid touch input occurred.

104. The host processor of claim 103, further comprising means for updating a touchscreen-scanning setting.

105. The host processor of claim 104, wherein means for updating the touchscreen-scanning setting comprises means for adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

106. The host processor of claim 105, further comprising:
means for maximizing the touch resolution in response to an “active” setting;
means for minimizing the touch resolution in response to a “standby” setting;
means for setting a mid-range touch resolution in response to a “semi-active” setting; and
means for disabling the touchscreen panel in response to a “sleep” setting.

107. The host processor of claim 106, wherein means for minimizing the touch resolution in response to a “standby” setting comprises:
means for aggregating all rows in the touchscreen area;
means for aggregating all columns in the touchscreen area;
means for adjusting a drive strength of a electronic signal sent through the touchscreen area to allow for scanning the aggregated rows and aggregated columns; and
means for performing future scans of the touchscreen area for touches on the aggregated rows and the aggregated columns.

108. The host processor of claim 106, wherein means for maximizing the touch resolution in response to an “active” setting comprises:
means for separating rows in the touchscreen area;
means for separating columns in the touchscreen area;
means for adjusting a drive strength of an electronic signal sent through the touchscreen area to allow for scanning individual rows and columns; and
means for performing future scans of the touchscreen area for touches on individual rows and individual columns.

109. The host processor of claim 106, wherein means for setting the mid-range touch resolution in response to a “semi-active” setting comprises:
means for aggregating a plurality of rows in the touchscreen area;
means for aggregating a plurality of columns in the touchscreen area;
means for adjusting a drive strength of a electronic signal sent through the touchscreen area to allow for scanning the aggregated rows and aggregated columns; and
means for performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

110. The host processor of claim 106, wherein means for disabling the touchscreen panel in response to a “sleep” setting comprises:
means for disabling the touchscreen area;
means for reducing a drive strength of a electronic signal sent through the touchscreen area to allow for no scanning; and
means for not performing scans of the touchscreen area.

111. The host processor of claim 99 further comprising means for sending calibration parameters to the transducer front end in response to an invalid touch input.

112. The host processor of claim 111, further comprising means for storing calibration parameters for use in calibrating a future touch signal.

113. The host processor of claim 111, wherein calibration parameters configure the transducer front end to calibrate a future touch signal sent from a touchscreen panel for use by the host processor.

114. The host processor of claim 113, wherein calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

115. A host processor configured for use with a touchscreen computing device comprising a touchscreen panel, wherein the host processor is configured with processor-executable instructions to perform operations comprising:
receiving a touch signal;
determining whether a valid touch input occurred; and
sending calibration parameters directly to a transducer front end of the touchscreen panel in response to an invalid touch input.

116. The host processor of claim 115, wherein the host processor is configured with processor-executable instructions to perform operations such that calibration parameters configure the transducer front end to calibrate future touch signals sent from a touchscreen panel for use by the host processor.

117. The host processor of claim 116, wherein the host processor is configured with processor-executable instructions to perform operations such that calibration parameters configure the transducer front end of the touchscreen panel to perform operations selected from a group comprising:
adaptively amplifying the future touch signal to normalize a signal-to-noise ratio caused by the transducer's location relative to the touchscreen panel;
over-sampling the future touch signal to enhance the signal-to-noise ratio;
correlating the future touch signal to enhance the signal-to-noise ratio; and
skewing a digital approximation of the future touch signal from an analog-to-digital converter to mitigate noise.

118. A host processor configured for use with a touchscreen computing device comprising a touchscreen panel, wherein the host processor is configured with processor-executable instructions to perform operations comprising:
receiving a touch signal;
determining whether a valid touch input occurred; and
updating a touch-processing state based on a determination of whether a valid touch input occurred.

119. The host processor of claim 118, wherein the host processor is configured with processor-executable instructions to perform operations further comprising updating a touchscreen-scanning setting.

120. The host processor of claim 119, wherein the host processor is configured with processor-executable instructions to perform operations such that updating the touchscreen-scanning setting comprises adaptively changing a touch resolution on a touchscreen area based on the touch-processing state by:
retrieving the touch-processing state; and
defining the touchscreen-scanning setting based on the touch-processing state,
wherein the touchscreen-scanning setting is one of an “active” setting, a “standby” setting, a “semi-active” setting, and a “sleep” setting, and
wherein the touchscreen area is at least a portion of a touchscreen panel.

121. The host processor of claim 120, wherein the host processor is configured with processor-executable instructions to perform operations further comprising:
maximizing the touch resolution in response to an “active” setting;
minimizing the touch resolution in response to a “standby” setting;
setting a mid-range touch resolution in response to a “semi-active” setting; and
disabling the touchscreen panel in response to a “sleep” setting.

122. The host processor of claim 121, wherein the host processor is configured with processor-executable instructions to perform operations such that minimizing the touch resolution in response to a “standby” setting comprises:
aggregating all rows in the touchscreen area;
aggregating all columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns.

123. The host processor of claim 121, wherein the host processor is configured with processor-executable instructions to perform operations such that maximizing the touch resolution in response to an “active” setting comprises:
separating rows in the touchscreen area;
separating columns in the touchscreen area;
adjusting a drive strength of an electronic signal sent through the touchscreen area to allow for scanning individual rows and columns; and
performing future scans of the touchscreen area for touches on individual rows and individual columns.

124. The host processor of claim 121, wherein the host processor is configured with processor-executable instructions to perform operations such that setting the mid-range touch resolution in response to a “semi-active” setting comprises:
aggregating a plurality of rows in the touchscreen area;
aggregating a plurality of columns in the touchscreen area;
adjusting a drive strength of a electronic signal sent through the touchscreen area to allow for scanning the aggregated rows and aggregated columns; and
performing future scans of the touchscreen area for touches on the aggregated rows and the aggregated columns,
wherein:
the plurality of rows is less than a total number of rows of the touchscreen panel; and
the plurality of columns is less than a total number of columns of the touchscreen panel.

125. The host processor of claim 121, wherein the host processor is configured with processor-executable instructions to perform operations further comprising such that disabling the touchscreen panel in response to a “sleep” setting comprises:
disabling the touchscreen area;
reducing a drive strength of a electronic signal sent through the touchscreen area to allow for no scanning; and
not performing scans of the touchscreen area.
